(19) United States
(12) Patent Application Publication
(10) Pub. No.: US 2002/0196590 A1
(43) Pub. Date: Dec. 26, 2002

(54) Spin-valve thin film magnetic element and thin film magnetic head

(75) Inventors: Masamichi Saito, Niigata-ken (JP); Kenichi Tanaka, Niigata-ken (JP); Yosuke Ide, Niigata-ken (JP); Naoya Hasegawa, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/208,392

(22) Filed: Jul. 29, 2002

Related U.S. Application Data
(62) Division of application No. 09/697,659, filed on Oct. 26, 2000.

(30) Foreign Application Priority Data
Nov. 11, 1999 (JP) 11-321801

(51) Int. Cl. G11B 5/39

(52) U.S. Cl. 360/324.11; 360/324.12

(57) ABSTRACT

The present invention provides a spin-valve thin film magnetic element comprising an antiferromagnetic layer, a pinned magnetic layer in which the direction of magnetization is fixed by an exchange coupling magnetic field with the antiferromagnetic layer, a non-magnetic conductive layer, and a free magnetic layer, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a NiFe layer at the side making contact with at least the non-magnetic intermediate layer, the non-magnetic intermediate layer comprises Ru with a thickness of 0.27 to 1.03 nm, and the magnitude of the saturation magnetization when the directions of magnetization of the first and second magnetic layers are parallel to one another is larger than 40 kA/m.

### BACKGROUND OF THE INVENTION

1. Field of the Invention

The present invention relates to a spin-valve thin film magnetic element and a thin film magnetic head. The present invention in particular relates to a spin-valve thin film magnetic element comprising a synthetic ferrimagnetic free layer and/or a synthetic ferrimagnetic pinned layer constructed by inserting a non-magnetic intermediate layer between two magnetic layers, and a thin film magnetic head comprising the thin film magnetic element.

2. Description of the Related Art

Magnetoresistive magnetic heads include a MR (Magnetoresistive) head comprising a magnetoresistive element and a GMR (Giant Magnetoresistive) head comprising a giant magnetoresistive element. The magnetoresistive element in the MR head has a monolayer structure of a magnetic material. The giant magnetoresistive element in the GMR head has, on the other hand, a multilayer structure in which plural materials are laminated. Although there are several kinds of structures that yield the giant magnetoresistive effect, the spin-valve type thin film magnetic element has a relatively simple structure with a high rate of change of resistance against external magnetic fields.

Since magnetic recording density has been required to be higher in recent years, the spin-valve type thin film magnetic head that can comply with high magnetic recording density has been noticed.

The conventional spin-valve type thin film magnetic head will be described with reference to drawings. FIG. 29 illustrates a cross section of the conventional spin-valve type thin film magnetic head 101 viewed from a magnetic recording medium side, and FIG. 30 illustrates a cross section of the conventional spin-valve type thin film magnetic head 101 viewed along the track width direction.

Shield layers are formed at on and under the spin-valve type thin film magnetic head 101 via a gap layer, and a regenerative thin film magnetic head is composed of the spin-valve type thin film magnetic head 101, the gap layer and the shield layer. A recording inductive head may be laminated on the thin film magnetic head.

The thin film magnetic head is provided at an end at a trailing ring side of a floating type slider, and constitutes the thin film magnetic head together with an inductive head for sensing recording magnetic fields from the magnetic recording medium such as a hard disk.

The Z-direction and Y-direction in FIGS. 29 and 30 denote the travel direction of the magnetic recording medium and the direction of the leak magnetic field from the magnetic recording medium, respectively, and the X₁ direction denotes the track width direction of the spin-valve type thin film magnetic element.

The spin-valve type thin film magnetic element 101 shown in FIGS. 29 and 30 is a bottom type single spin-valve type thin film magnetic element comprising an anti-ferromagnetic layer 103, a pinned magnetic layer 104, a non-magnetic conductive layer 105 and a free magnetic layer 111 sequentially laminated in this order.

The reference numeral 100 in FIGS. 29 and 30 denotes an insulation layer formed of an insulation material such as Al₂O₃, and the reference numeral 102 denotes a substrate layer comprising Ta (tantalum) laminated on the insulation layer 100. The anti-ferromagnetic layer 103 is laminated on this substrate layer 102, the pinned magnetic layer 104 is laminated on the anti-ferromagnetic layer 103, the non-magnetic conductive layer 105 made of Cu is laminated on the pinned magnetic layer 104, the free magnetic layer 111 is laminated on the non-magnetic conductive layer 105, and a protective layer 120 made of Ta is laminated on the free magnetic layer 111.

A laminated body 121 having a width corresponding to the track width and an approximately trapezoidal cross section is constructed by sequentially laminating each layer of from the substrate layer 102 through the protective layer 120.

The pinned magnetic layer 104 comprises a non-magnetic intermediate layer 113, and first and second pinned magnetic layers 112 and 114 facing to one another across the non-magnetic intermediate layer 113. The first pinned magnetic layer 112 is provided at the anti-ferromagnetic layer 103 side relative to the non-magnetic intermediate layer 113, and the second pinned magnetic layer 114 is provided at the non-magnetic conductive layer 105 side relative to the non-magnetic intermediate layer 113.

The first and second pinned magnetic layers 112 and 114 are made of a ferromagnetic material such as a NiFe alloy. The non-magnetic intermediate layer 113 is made of a non-magnetic material such as Ru. The first and second pinned magnetic layers 112 and 114 are preferably made of the same material to one another.

It is preferable that the thickness of the first pinned magnetic layer 112 is slightly different from the thickness of the second pinned magnetic layer 114. The thickness of the second pinned magnetic layer 114 is adjusted to be larger than the thickness of the first pinned magnetic layer 112 in FIGS. 29 and 30.

An exchange coupling magnetic field (an exchange anisotropic coupling magnetic field) is generated at the interface between the first pinned magnetic layer 112 and the anti-ferromagnetic layer 103. The direction of magnetization of the first pinned magnetic layer 112 is fixed toward the Y-direction by the exchange coupling magnetic field with the anti-ferromagnetic layer 103, and the direction of magnetization of the second pinned magnetic layer 114 is fixed toward the opposite direction to the Y-direction by an anti-ferromagnetic coupling with the first pinned magnetic layer 112.

The direction of magnetization of the first pinned magnetic layer 112 is anti-parallel to the direction of magnetization of the second pinned magnetic layer 114, and the magnetic moment of the first pinned magnetic layer 112 cancels the magnetic moment of the second pinned magnetic layer 114. However, since the thickness tP₁ of the first pinned magnetic layer 112 is slightly larger than the thickness tP₂ of the second pinned magnetic layer 114, a few magnitude of spontaneous magnetization remains due to the contribution of the first pinned magnetic layer 112 to leave the pinned magnetic layer 104 to be in a ferrimagnetic state. This spontaneous magnetization is further amplified by the exchange coupling magnetic field with the antiferromagnetic layer 103 to fix the direction of magnetization of the pinned magnetic layer 104 toward the Y-direction.

The free magnetic layer 111 comprises a non-magnetic intermediate layer 109, and a first free magnetic layer 110 and a second free magnetic layer 108 facing to one another across the non-magnetic intermediate layer 109. The first free magnetic layer 110 is provided at the protective layer 120 side relative to the non-magnetic intermediate layer 109, and the second free magnetic layer 108 is provided at the non-magnetic conductive layer 105 side relative to the non-magnetic intermediate layer 109.

The thickness tF₁ of the first free magnetic layer 110 is adjusted to be larger than thickness tF₂ of the second free magnetic layer 108.

The first free magnetic layer 110 is made of a ferromagnetic material such as a NiFe alloy, and the non-magnetic intermediate layer 109 is made of a non-magnetic material such as Ru.

The second free magnetic layer 108 comprises a diffusion preventive layer 106 and an ferromagnetic layer 107. Both of the diffusion preventive layer 106 and the ferromagnetic layer 107 are made of a ferromagnetic. material, the diffusion preventive layer 106 is made of, for example, Co, and the ferromagnetic layer 107 is made of a NiFe alloy.

The first free magnetic layer 110 and the ferromagnetic layer 107 are preferably made of the same material with each other.

The diffusion preventive layer 106 is provided so as to prevent diffusion between the ferromagnetic layer 107 and the non-magnetic conductive layer 105.

Magnetic film thickness of the first free magnetic layer 110 and the magnetic film thickness of the second free magnetic layer 108 are represented by M₁·t₁ and M₂·t₂, respectively, wherein M₁ and M₂ denotes saturation magnetization of the first free magnetic layer 110 and the second free magnetic layer 108, respectively.

Since the second free magnetic layer 108 is composed of the diffusion preventive layer 106 and the ferromagnetic layer 107, the magnetic film thickness M₂·t₂ of the second free magnetic layer 108 is represented by a sum of the magnetic film thickness of the diffusion preventive layer 106 and the magnetic film thickness of the ferromagnetic layer 107.

The free magnetic layer 111 is constructed so that the magnetic film thickness of the first free magnetic layer 110 and the magnetic film thickness of the second free magnetic layer 108 satisfy the relation of M₂·t₂>M₁·t₁.

Actually, the thickness t₁ of the first free magnetic layer 110 is made to be extremely larger than the thickness t₂ of the second free magnetic layer 108 in order to satisfy the relation of M₂·t₂>M₁·t₁, because saturation magnetization of Co constituting the diffusion preventive layer 106 is larger than saturation magnetization of the NiFe alloy constituting the ferromagnetic layer 107 and the first free magnetic layer 110.

The first free magnetic layer 110 and the second free magnetic layer 108 exhibit antiferromagnetic coupling between them. In other words, the direction of magnetization of the second free magnetic layer 108 aligns toward the opposite direction to the X₁-direction, when the direction of magnetization of the first free magnetic layer 110 is aligned toward the X₁-direction due to bias layers 132 and 132.

Since the magnetic film thickness of the first free magnetic layer 110 and the magnetic film thickness of the second free magnetic layer 108 satisfy the relation of M₁/t₁>M₂/t₂, the first free magnetic layer 110 has remnant magnetization and the direction of overall magnetization of the free magnetic layer 111 is aligned along the X₁-direction. The effective magnetic film thickness of the free magnetic layer 111 is represented by (M₁/t₁−M₂/t₂).

Apparent ferrimagnetic state arises as a result of antiferromagnetic coupling between the first free magnetic layer 110 and the second free magnetic layer 108 with antiparallel directions of magnetization to one another, and the relation of M₁/t₁>M₂/t₂ between the respective magnetic film thickness.

The relation as described above causes the direction of magnetization of the free magnetic layer 111 intersects the direction of magnetization of the pinned magnetic layer 104.

Bias layers 132 and 132 comprising, for example, a Co—Pt (a cobalt-platinum) alloy are formed at both sides of the laminated body 121. These bias layers 132 and 132 are provided in order to align the direction of magnetization of the first free magnetic layer 110 toward the X₁-direction to put the free magnetic layer 111 in a single domain state, and to suppress Barkhausen noises of the free magnetic layer 111.

The reference numerals 134 and 134 denote conductive layers made of Cu.

Bias substrate layers 131 comprising a non-magnetic metal such as Cr are provided between the bias layer 132 and the insulation layer 100, and between the bias layer 132 and the laminated body 121.

An intermediate layer 133 comprising a non-magnetic metal such as Ta or Cr is provided between the bias layer 132 and the conductive layer 134.

When the direction of magnetization of the free magnetic layer 111 aligned toward the X₁-direction fluctuates by the effect of leak magnetic field from a recording medium such as a hard disk in the spin-valve type thin film magnetic element 110, electrical resistance changes based on the relation with magnetization of the pinned magnetic layer 104 fixed toward the Y-direction. A leak magnetic field from the recording medium is sensed by taking advantage of this voltage change based on the electrical resistance change.

Since the free magnetic layer 111 is composed of the first and second free magnetic layers 110 and 108 displaying an antiferromagnetic coupling to one another, the direction of magnetization of the entire free magnetic layer 111 fluctuates by a minute magnitude of external magnetic field to enhance sensitivity of the spin-valve type thin film magnetic element 101.

Since the effective magnetic film thickness of the free magnetic layer 111 is adjusted to be (M₁·t₁−M₂·t₂), it is made possible to reduce the effective film thickness by appropriately adjusting the film thickness of the first and second free magnetic layers 110 and 108, thereby the direction of magnetization of the free magnetic layer readily fluctuates by a minute magnitude of the external magnetic field to enhance sensitivity of the spin-valve type thin film magnetic element 101.

The first and second pinned magnetic layers 112 and 114 displays an antiferromagnetic coupling to cancel the magnetic moments of the first and second pinned magnetic layers 112 and 114 to one another. However, since the thickness tP₁ of the first pinned magnetic layer 112 is slightly larger, a small magnitude of spontaneous magnetization ascribed to the first pinned magnetic layer 112 remains to put the pinned magnetic layer 104 into a ferrimagnetic state. Consequently, the spontaneous magnetization is amplified by an exchange coupling magnetic field with the antiferromagnetic layer 103 besides fixing the direction of magnetization of the pinned magnetic layer 104 toward the Y-direction, thereby improving stability of the spin-valve type thin film magnetic element 121.

The thickness t₁ of the of the first free magnetic layer 110 comprising NiFe is made to be extremely larger than the thickness t₂ of the of the second free magnetic layer 108 comprising NiFe in the conventional spin-valve type thin film magnetic element 101, in order to allow the relation of M₁.t₁>M₂.t₂ to be valid.

However, the magnetic field that causes spin-flop transition of the free magnetic field 111, or so-called a spin-flop magnetic field H_{sf}, is reduced in addition to reducing the saturation magnetic field (Hₛ) of the free magnetic field 111, even when the thickness t₁ of the first free magnetic field 111 is made to be extremely larger than the thickness t₂ of the second free magnetic field 108 to make the relation of M₁.t₁>M₂.t₂ to be valid.

When the thickness tP₁ of the first pinned magnetic layer 112 is adjusted to be slightly larger than the thickness tP₂ of the second pinned magnetic layer 114, on the other hand, the magnetic field that causes spin-flop transition of the pinned magnetic field 104, or a so-called spin-flop magnetic field (H_{sf}), is reduced, or the saturation magnetic field (Hₛ) of the pinned magnetic field 104 is reduced.

The spin-flop magnetic field (H_{sf}) refers to the magnitude of an external magnetic field where an antiparallel relation between two magnetic layers starts to collapse, or a perfect ferrimagnetic relation starts to collapse, when an external magnetic field parallel to the direction of magnetization of one of the magnetic layers is applied to the two magnetic layers having antiparallel directions of magnetization to one another. The bias magnetic field from the bias layer 132 corresponds to the external magnetic field in this example.

When the H_{sf} value of the free magnetic layer 111 is small as described above, the free magnetic layer 111 has a narrow range for maintaining the ferrimagnetic state. When the magnitude of the external magnetic field exceeds H_{sf}, antiferromagnetic coupling between the first and second free magnetic layers 110 and 108 is liable to be broken since the direction of magnetization of the free magnetic layer 110 is not aligned to be antiparalle to the direction of magnetization of the free magnetic layer 108, causing a possibility that ferrimagnetic state of the ferrimagnetic layer 111 cannot be maintained.

When the H_{sf} value of the pinned magnetic layer 104 is small, on the other hand, the pinned magnetic layer 104 has a narrow range for maintaining the ferrimagnetic state. When the magnitude of the external magnetic field exceeds H_{sf}, the direction of magnetization of the first pinned magnetic layer 112 is not aligned to be antiparallel to the direction of magnetization of the second pinned magnetic layer 114 to make it impossible to maintain the ferrimagnetic state of the pinned magnetic layer 104. In addition, since the overall pinned magnetic layer 104 cannot leave a minute magnitude of spontaneous magnetization, the direction of magnetization of the pinned magnetic layer 104 cannot be tightly fixed by amplifying spontaneous magnetization by the exchange coupling magnetic field with the antiferromagnetic layer 103.

The saturation magnetic field (Hₛ) refers to the magnitude of the magnetic field when respective directions of magnetization of the two magnetic layers are saturated along the direction of applied magnetic field in parallel relation to one another, after applying a magnetic field parallel to the direction of magnetization of one of the two magnetic layers magnetized to be antiparallel to one another.

When the magnitude of Hₛ of the free magnetic layer 111 is reduced, the magnitude of H_{sf} is also reduced. When the magnitude of the external magnetic field exceeds Hₛ, on the other hand, antiferromagnetic coupling between the first and second free magnetic layers 112 and 114 is broken to make the directions of magnetization of the first and second free magnetic layers 110 and 118 to be parallel to one another, making it impossible to maintain ferrimagnetic state of the free magnetic layer 111.

When the saturation magnetic field (Hₛ) of the pinned magnetic layer 104 is reduced, H_{sf} is also reduced. When the magnitude of the magnetic field exceeds Hₛ, on the other hand, the directions of magnetization of the first and second pinned magnetic layers 112 and 114 turn out to be in parallel relation to one another to fail in maintaining ferrimagnetic state of the pinned magnetic layer 104. Consequently, the pinned magnetic layer 104 cannot exhibit remnant spontaneous magnetization as a whole, or the direction of magnetization of the pinned magnetic layer 104 cannot be fixed by amplifying this spontaneous magnetization by the exchange coupling magnetic field with the antiferromagnetic layer 103.

Accordingly, the higher spin-flop magnetic field (H_{sf}) and saturation magnetization (Hₛ) in the spin-valve type thin film magnetic element permits the range of the magnetic field where the free magnetic layer and pinned magnetic layer are maintained in ferrimagnetic state to be expanded, and the free magnetic layer and pinned magnetic layer to be maintained in stable ferrimagnetic state, thereby affording good characteristics as the spin-valve type thin film magnetic element.

When the thickness of a Ru layer sandwiched by two NiFe layers such as the non-magnetic intermediate layer 109 of the free magnetic layer 111, and the non-magnetic intermediate layer 113 of the pinned magnetic layer 104 is particularly noticed, it was found by the inventors of the present invention that the thickness of the Ru layer as a non-magnetic intermediate layer is correlated to the spin-flop magnetic field (H_{sf}) and saturation magnetic field (Hₛ).

The inventors of the present invention also found that combinations of the material of non-magnetic layers and the material of two magnetic layers facing across the non-magnetic layer to one another, and the thickness of the non-magnetic intermediate layer in each combination, are correlated to the spin-flop magnetic field (H_{sf}) and saturation magnetic field (Hₛ).

### SUMMARY OF THE INVENTION

Accordingly, the object of the present invention carried out in view of the situations as described above is to provide a spin-valve thin film magnetic element in which at least one of the pinned magnetic layer and the free magnetic layer comprises two magnetic layers facing across a non-magnetic intermediate layer to one another, and which is able to maintain stable ferrimagnetic state by expanding the range of the magnetic field that maintains ferrimagnetic state of at least one of the pinned magnetic layer and the ferrimagnetic layer, and a thin film magnetic head having a large regenerative output by providing the spin-valve type magnetic element.

For attaining the objects, the present invention provides in a first aspect a spin-valve thin film magnetic element comprising an antiferromagnetic layer, a pinned magnetic layer formed in contact with the antiferromagnetic layer in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a NiFe layer at the side making contact with at least the non-magnetic intermediate layer, the non-magnetic intermediate layer comprises Ru with a thickness of 0.27 to 1.03 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pined magnetic layer is composed of the non-magnetic intermediate layer comprising Ru, and the first and second magnetic layers having the NiFe layer at the side in contact with the non-magnetic intermediate layer, and the thickness of the non-magnetic intermediate layer is adjusted within the range as described above. Consequently, the saturation magnetic field (Hₛ) of at least one of the free magnetic layer and the pinned magnetic layer turns out to be larger than 40 kA/m. Accordingly, the directions of magnetization of the first and second magnetic layers constituting the free magnetic layer are antiparallel to one another, when the saturation magnetic field (Hₛ) of the free magnetic layer is larger than 40 kA/m. In addition, since the spin-flop magnetic field (H_{sf}) that causes spin-flop transition in the first and second magnetic layers may be increased, antiferromagnetic coupling between the first and second magnetic layers that constitutes the free magnetic layer may be securely maintained to enhance sensitivity of the spin-valve type thin film magnetic element.

When the saturation magnetic field (Hₛ) of the pinned magnetic layer is larger than 40 kA/m, the directions of magnetization of the first and second magnetic layers constituting the pinned magnetic layer are aligned to be antiparallel to one another. Since the pinned magnetic layer has a minute quantity of remnant spontaneous magnetization as a whole, besides enabling the spin-flop magnetic field (H_{sf}) that causes spin-flop transition in the first and second magnetic layers to be increased, the spontaneous magnetization is amplified by an exchange coupling magnetic field with the antiferromagnetic layer to enable the direction of magnetization of the pinned magnetic layer to be securely fixed.

Preferably, the thickness of the non-magnetic intermediate layer comprising Ru is 0.32 to 1.03 nm instead of 0.27 to 1.03 nm, and the spin-flop magnetic field (H_{sf}) that causes spin-flop transition in the first and second magnetic layers is larger than 4 kA/m, instead of the saturation magnetic field of larger than 40 kA/m when the directions of magnetization of the first and second magnetic layers are parallel to one another.

At least one of the free magnetic layer and the pinned magnetic layer is composed of a non-magnetic intermediate layer comprising Ru, and first and second magnetic layers having a NiFe layer at the side in contact with the non-magnetic intermediate layer, and the thickness of the non-magnetic intermediate layer is adjusted within the range described above. Consequently, the spin-flop magnetic field (H_{sf}) of at least one of the free magnetic layer and the pinned magnetic layer becomes to be larger than 4 kA/m. Therefore, the range where the ferrimagnetic layer is maintained in a ferrimagnetic state may be expanded when the spin-flop magnetic field (H_{sf}) of the free magnetic layer is larger than 4 kA/m, thereby allowing an antiferromagnetic coupling between the first and second magnetic layers constituting the free magnetic layer to be securely maintained to enhance sensitivity of the spin-valve type thin film magnetic element.

When the spin-flop magnetic field (H_{sf}) of the pinned magnetic layer is larger than 4 kA/m, the directions of magnetization of the first and second magnetic layers constituting the pinned magnetic layer are aligned to be antiparallel to one another. Since the pinned magnetic layer has a minute quantity of remnant spontaneous magnetization as a whole, besides expanding the range for maintaining the pinned magnetic layer in a ferrimagnetic state, the spontaneous magnetization is amplified by an exchange coupling magnetic field with the antiferromagnetic layer to enable the direction of magnetization of the pinned magnetic layer to be securely fixed.

Preferably, the saturation magnetic field when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Ru, and the first and second magnetic layers having a NiFe layer at the side in contact with the non-magnetic intermediate layer. Since the thickness of the non-magnetic intermediate layer is determined to be within the range as described above, the saturation magnetic field (Hₛ) and the spin-flop magnetic field (H_{sf}) of at least one of the free magnetic layer and pinned magnetic layer may be made to be larger than 40 kA/m and 4 kA/m, respectively.

In a second aspect, the present invention provides a spin-valve thin film magnetic element comprising an antiferromagnetic layer, a pinned magnetic layer formed in contact with the antiferromagnetic layer in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a NiFe layer at the side making contact with at least the non-magnetic intermediate layer, the non-magnetic intermediate layer comprises Cr with a thickness of 0.97 to 1.16 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Cr, and the first and second magnetic layers having a NiFe layer at the side in contact with the non-magnetic intermediate layer. In addition, since the thickness of the non-magnetic intermediate layer is adjusted within the range as described above, the saturation magnetic field (Hₛ) of the free magnetic layer and the pinned magnetic layer is made to be larger than 40 kA/m to display the same effect as hitherto described.

Preferably, the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

In the spin-valve type thin film magnetic element as described above, at least one of the free magnetic layer and the pinned magnetic layer comprises a non-magnetic intermediate layer comprising Cr and the first and second magnetic layers having a NiFe layer at the side making contact with the non-magnetic intermediate layer, besides adjusting the thickness of the non-magnetic intermediate layer within the range as described above. Accordingly, the same effect as hitherto described may be obtained.

In a third aspect, the present invention provides a spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic Layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a NiFe layer at the side making contact with at least the non-magnetic intermediate layer, the non-magnetic intermediate layer comprises Ir with a thickness of 0.27 to 0.59 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Ir and the first and second magnetic layers having a NiFe layer at the side making contact with the non-magnetic intermediate layer, besides adjusting the thickness of the non-magnetic intermediate layer within the range as described above. Accordingly, the saturation magnetic field (Hₛ) of at least one of the free magnetic layer and the pinned magnetic layer is made to be larger than 40 kA/m to exhibit the same effect as hitherto described.

Preferably, the thickness of the non-magnetic intermediate layer comprising Ir is 0.32 to 0.59 nm instead of 0.27 to 0.59 nm, and the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

In the spin-valve type thin film magnetic element as described above, at least one of the free magnetic layer and the pinned magnetic layer comprises a non-magnetic intermediate layer comprising Ir and the first and second magnetic layers having a NiFe layer at the side making contact with the non-magnetic intermediate layer, besides adjusting the thickness of the non-magnetic intermediate layer within the range as described above. Accordingly, the same effect as hitherto described may be obtained.

The saturation magnetization when the directions of magnetization of the first and second magnetic layers are parallel to one another may be larger than 40 kA/m.

In the spin-valve type thin film magnetic element as described above, at least one of the free magnetic layer and the pinned magnetic layer comprises a non-magnetic intermediate layer comprising Ir and the first and second magnetic layers having a NiFe layer at the side making contact with the non-magnetic intermediate layer, besides adjusting the thickness of the non-magnetic intermediate layer within the range as described above. Accordingly, the same effect as hitherto described may be obtained.

In a fourth aspect, the present invention provides a spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a NiFe layer at the side making contact with at least the non-magnetic intermediate layer, the non-magnetic intermediate layer comprises Ru with a thickness of 0.44 to 0.88 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Rh and the first and second magnetic layers having a NiFe layer at the side making contact with the non-magnetic intermediate layer, besides adjusting the thickness of the non-magnetic intermediate layer within the range as described above. Accordingly, the saturation magnetic field (Hₛ) of at least one of the free magnetic layer and the pinned magnetic layer may be adjusted to be larger than 40 kA/m to exhibit the same effect as hitherto described.

Preferably, the thickness of the non-magnetic intermediate layer comprising Rh is 0.55 to 0.83 nm or 1.54 to 1.87 nm instead of 0.44 to 0.88 nm, and the spin-flop magnetic field that causes spin-flop transition in the first and second magnetic layers is larger than 4 kA/m instead of the saturation magnetic field of larger than 40 kA/m when the first and second magnetic layers are parallel to one another.

In the spin-valve type thin film magnetic element as described above, at least one of the free magnetic layer and the pinned magnetic layer comprises a non-magnetic intermediate layer comprising Rh and the first and second magnetic layers having a NiFe layer at the side making contact with the non-magnetic intermediate layer, besides adjusting the thickness of the non-magnetic intermediate layer within the range as described above. Accordingly, the same effect as hitherto described may be obtained.

Preferably, the thickness of the non-magnetic intermediate layer comprising Rh is 0.55 to 0.83 nm instead of 0.55 to 0.83 nm or 1.54 to 1.87 nm, and the saturation magnetic field when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Rh and the first and second magnetic layers having a NiFe layer at the side making contact with the non-magnetic intermediate layer, besides adjusting the thickness of the non-magnetic intermediate layer within the range as described above. Accordingly, the same effect as hitherto described may be obtained.

In a fifth aspect, the present invention provides a spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a Co layer at the side making contact with at least the non-magnetic intermediate layer, the non-magnetic intermediate layer comprises Ru with a thickness of 0.38 to 1.03 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Rh and the first and second magnetic layers having a NiFe layer at the side making contact with the non-magnetic intermediate layer, besides adjusting the thickness of the non-magnetic intermediate layer within the range as described above. Accordingly, the same effect as hitherto described may be obtained.

Preferably, the spin-flop magnetic field that causes spin-flop transition of the first and second magnetic layers is larger than 4 kA/m, instead of the saturation magnetic field of larger than 40 kA/m when the directions of magnetization of the first and second magnetic layers are parallel to one another.

In the spin-valve type thin film magnetic element as described above, at least one of the free magnetic layer and the pinned magnetic layer comprises a non-magnetic intermediate layer comprising Ru and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

The saturation magnetic field when the directions of magnetization of the first and second magnetic layers are parallel to one another may be larger than 40 kA/m.

In the spin-valve type thin film magnetic element as described above, at least one of the free magnetic layer and the pinned magnetic layer comprises a non-magnetic intermediate layer comprising Ru and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

In a sixth aspect, the present invention provides a spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a Co layer at the side making contact with at least the non-magnetic intermediate layer, the non-magnetic intermediate layer comprises Cr with a thickness of 0.87 to 1.46 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Cr and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

Preferably, the thickness of the non-magnetic intermediate layer comprising Cr is 0.97 to 1.46 nm instead of 0.87 to 1.46 nm, and the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

In the spin-valve type thin film magnetic element as described above, at least one of the free magnetic layer and the pinned magnetic layer comprises a non-magnetic intermediate layer comprising Cr and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

The saturation magnetic field when the directions of magnetization of the first and second magnetic layers are in parallel to one another may be larger than 40 kA/m.

In the spin-valve type thin film magnetic element as described above, at least one of the free magnetic layer and the pinned magnetic layer comprises a non-magnetic intermediate layer comprising Cr and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

In a seventh aspect, the present invention provides a spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a Co layer at the side making contact with at least the non-magnetic intermediate layer, the non-magnetic intermediate layer comprises Ir with a thickness of 0.27 to 0.7 nm or 1.3 to 1.62 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Ir and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

Preferably, the thickness of the non-magnetic intermediate layer comprising Ir is 0.43 to 0.65 nm instead of 0.27 to 0.7 nm or 1.3 to 1.62 nm, and the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

In the spin-valve type thin film magnetic element as described above, at least one of the free magnetic layer and the pinned magnetic layer comprises a non-magnetic intermediate layer comprising Ir and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

The saturation magnetization when the first and second magnetic layers are parallel to one another may be larger than 40 kA/m.

In the spin-valve type thin film magnetic element as described above, at least one of the free magnetic layer and the pinned magnetic layer comprises a non-magnetic intermediate layer comprising Ir and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

In a eighth aspect, the present invention provides a spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer, the non-magnetic conductive layer, the pinned magnetic layer and the antiferromagnetic layer being provided on one side or on both sides of the free magnetic layer along the direction of thickness, at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state, wherein each of the first and second magnetic layers has a Co layer at the side making contact with at least the non-magnetic intermediate layer, the non-magnetic intermediate layer comprises Rh with a thickness of 0.44 to 0.99 nm or 1.54 to 1.98 nm, and the magnitude of the saturation magnetization when the directions of magnetization of the first and second magnetic layers are parallel to one another is larger than 40 kA/m.

In the spin-valve type thin film magnetic element as described above, at least one of the free magnetic layer and the pinned magnetic layer comprises a non-magnetic intermediate layer comprising Rh and the first and second magnetic layers having a Co layer at the side making contact with the non-magnetic intermediate layer, besides adjusting the thickness of the non-magnetic intermediate layer within the range as described above. Accordingly, the same effect as hitherto described may be obtained.

The antiferromagnetic layer may comprise one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

The antiferromagnetic layer in the spin-valve type thin film magnetic element as described above has a higher blocking temperature where the exchange coupling magnetic field (an exchange anisotropic magnetic field) is extinguished and larger exchange coupling magnetic field, and being excellent in corrosion resistance, as compared with antiferromagnetic layers comprising NiMn and FeMn. Accordingly, the antiferromagnetic layer hardly suffers deterioration of characteristics due to oxidation in the air, and diffusion of oxygen in the gap layer provided above and below the spin-valve type thin film magnetic element into the antiferromagnetic layer.

Preferably, the antiferromagnetic layer comprises α-Fe₂O₃.

The antiferromagnetic layer in the spin-valve type thin film magnetic element as described above preferably has a higher blocking temperature where the exchange coupling magnetic field is extinguished, and larger exchange coupling magnetic field (an excahne anisotropic magnetic field) as compared with the antiferromagnetic layers comprising the alloys represented by the formulae of X—Mn and X′—Mn.

The present invention also provides a thin film magnetic head comprising the spin-valve type thin film magnetic element.

Since the thin film magnetic head described above comprises the spin-valve type thin film magnetic element having high sensitivity, a minute magnitude of external magnetic fields may be sensed to permit reproduction output voltages of the head to be increased, making it possible to use the magnetic head in a magnetic recording device having a high recording density.

### BRIEF DESCRIPTION OF THE DRAWINGS

FIG. 1 illustrates a cross section of the spin-valve type thin film magnetic element as a first embodiment of the present invention viewed from the magnetic recording medium side;

FIG. 2 illustrates a cross section of the spin-valve type thin film magnetic element shown in FIG. 1 viewed from the track width side;

FIG. 3 is a perspective view of the floating type magnetic head provided with the thin film magnetic head according to the present invention;

FIG. 4 is a cross section of the main part of the floating type magnetic head shown in FIG. 3;

FIG. 5 shows a M-H curve of the free magnetic layer of the spin-valve type thin film magnetic head shown in FIG. 1;

FIG. 6 illustrates a manufacturing process of the spin-valve type thin film magnetic head in the first embodiment according to the present invention;

FIG. 7 illustrates a cross section of the spin-valve type thin film magnetic head as a second embodiment of the present invention viewed from the magnetic recording medium side;

FIG. 8 illustrates a cross section of the spin-valve type thin film magnetic head shown in FIG. 7 viewed from the track width side;

FIG. 9 illustrates a cross section of the spin-valve type thin film magnetic head as a third embodiment of the present invention viewed from the magnetic recording medium side;

FIG. 10 illustrates a cross section of the spin-valve type thin film magnetic head shown in FIG. 9 viewed from the track width side; .

FIG. 11 illustrates a cross section of the spin-valve type thin film magnetic head as a fourth embodiment of the present invention viewed from the magnetic recording medium side;

FIG. 12 illustrates a cross section of the spin-valve type thin film magnetic head shown in FIG. 11 viewed from the track width side;

FIG. 13 is a graph showing the relation between the thickness of the Ru layer and Hₛ in the magnetic layer of the NiFe/Ru/NiFe structure;

FIG. 14 is a graph showing the relation between the thickness of the Ru layer and H_{sf} in the magnetic layer of the NiFe/Ru/NiFe structure;

FIG. 15 is a graph showing the relation between the thickness of the Cr layer and Hₛ in the magnetic layer of the NiFe/Cr/NiFe structure;

FIG. 16 is a graph showing the relation between the thickness of the Cr layer and H_{sf} in the magnetic layer of the NiFe/Cr/NiFe structure;

FIG. 17 is a graph showing the relation between the thickness of the Ir layer and Hₛ in the magnetic layer of the NiFe/Ir/NiFe structure;

FIG. 18 is a graph showing the relation between the thickness of the Ir layer and H_{sf} in the magnetic layer of the NiFe/Ir/NiFe structure;

FIG. 19 is a graph showing the relation between the thickness of the Rh layer and Hₛ in the magnetic layer of the NiFe/Rh/NiFe structure;

FIG. 20 is a graph showing the relation between the thickness of the Rh layer and H_{sf} in the magnetic layer of the NiFe/Rh/NiFe structure;

FIG. 21 is a graph showing the relation between the thickness of the Ru layer and Hₛ in the magnetic layer of the Co/Ru/Co structure;

FIG. 22 is a graph showing the relation between the thickness of the Ru layer and H_{sf} in the magnetic layer of the Co/Ru/Co structure;

FIG. 23 is a graph showing the relation between the thickness of the Cr layer and Hₛ in the magnetic layer of the Co/Cr/Co structure;

FIG. 24 is a graph showing the relation between the thickness of the Cr layer and H_{sf} in the magnetic layer of the Co/Cr/Co structure;

FIG. 25 is a graph showing the relation between the thickness of the Ir layer and Hₛ in the magnetic layer of the Co/Ir/Co structure;

FIG. 26 is a graph showing the relation between the thickness of the Ir layer and H_{sf} in the magnetic layer of the Co/Ir/Co structure;

FIG. 27 is a graph showing the relation between the thickness of the Rh layer and Hₛ in the magnetic layer of the Co/Rh/Co structure;

FIG. 28 is a graph showing the relation between the thickness of the Rh layer and H_{sf} in the magnetic layer of the Co/Rh/Co structure;

FIG. 29 illustrates a cross section of the conventional spin-valve type thin film magnetic element viewed from the magnetic recording medium side; and

FIG. 30 illustrates a cross section of the conventional spin-valve type thin film magnetic element viewed from the track width side.

### DESCRIPTION OF THE PREFERRED EMBODIMENTS

The present invention will be described hereinafter with reference to the drawings.

### First Embodiment

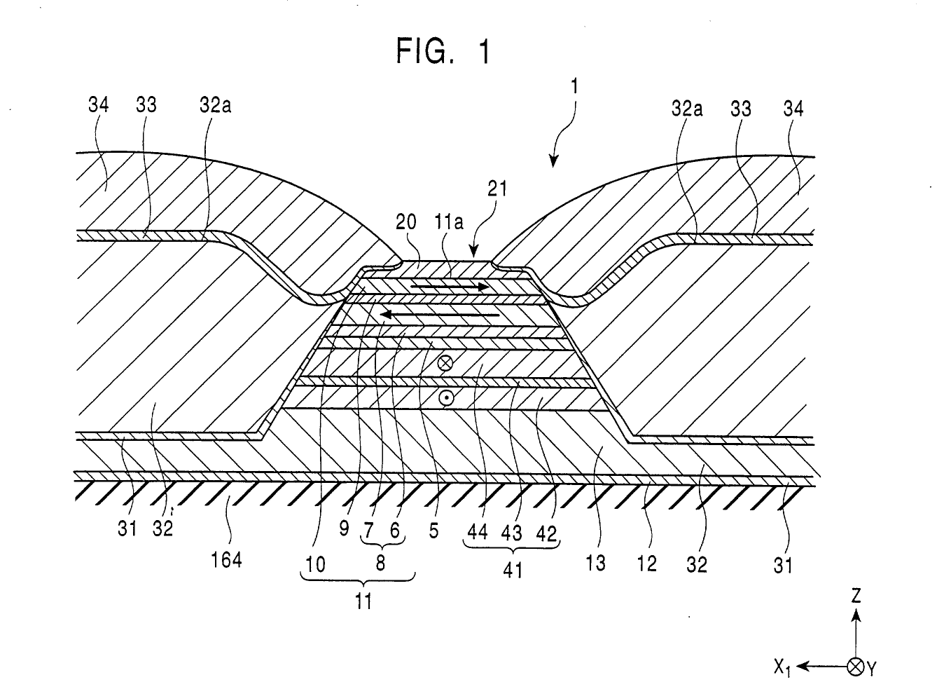

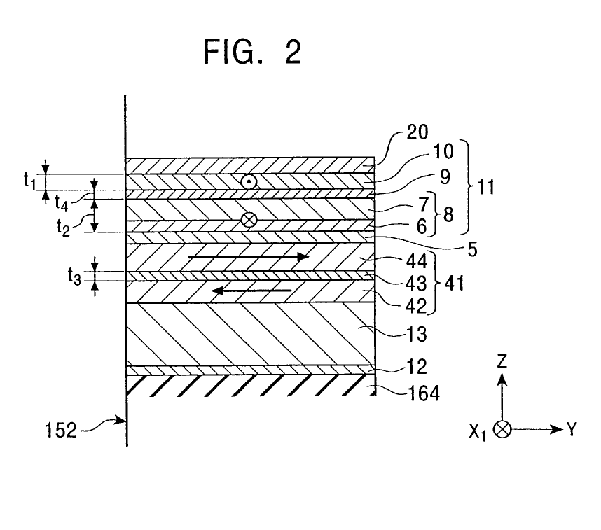

FIG. 1 shows a cross section of the spin-valve type thin film magnetic element as a first embodiment of the present invention viewed from the magnetic recording medium side, and FIG. 2 shows a cross section of this spin-valve type thin film magnetic element viewed from the track width side.

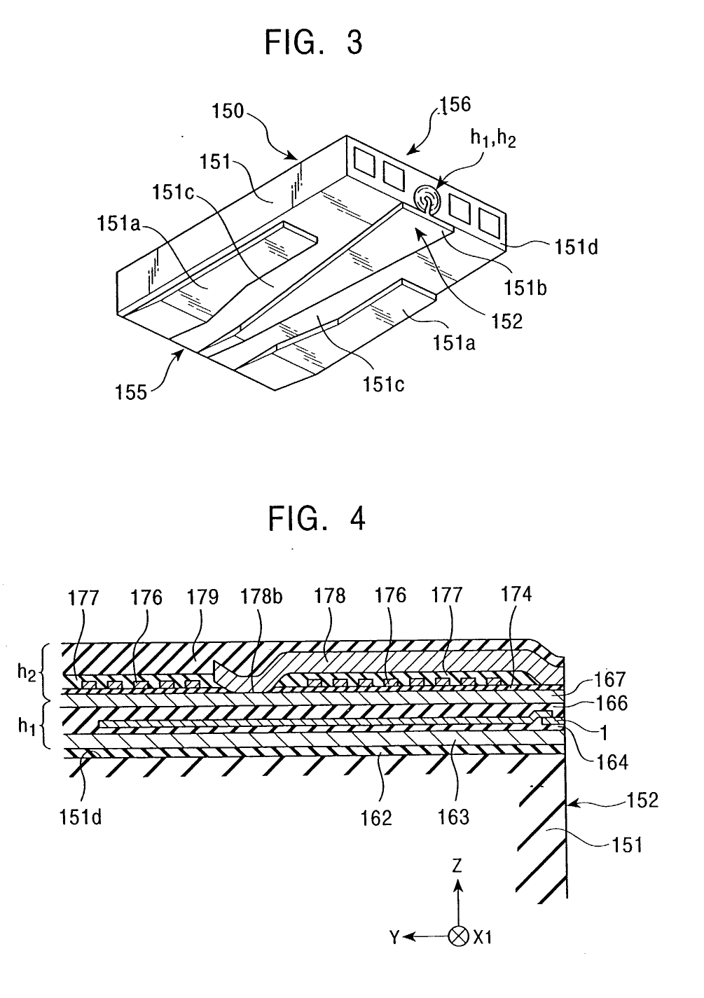

FIGS. 3 and 4 show a floating type magnetic head provided with the thin film magnetic head comprising the spin-valve type thin film magnetic element.

The floating type magnetic head 150 shown in FIG. 3 mainly comprises a slider 151, a thin film magnetic head h₁ and an inductive head h₂ according to the present invention provided at an end face 151d of the slider 151. The reference numeral 155 denotes the leading side at an upper stream side along the travel direction of the recording medium of the slider 151, and the reference numeral 156 denote the trailing side. Rails 151a, 151a and 151b are formed on the opposite face 152 to the slider 151, and air groups 151c and 151c are provided among the rails.

As shown in FIGS. 3 and 4, the thin film magnetic head h₁ according to the present invention comprises an insulation layer 162 formed on the end face 151d of the slider 151, a lower shield layer 163 laminated on the insulation layer 162, a lower gap layer 164 laminated on the lower shield layer 163, a spin-valve thin film magnetic head 1 according to the present invention formed on the lower gap layer 164 and exposed on the opposed face 152 to the recording medium, an upper gap layer 166 covering the spin-valve type thin film magnetic head 1, and an upper shield layer 167 covering the upper gap layer 166.

The upper shield layer 167 also serves as a lower core layer of the an inductive head h₂ to be described hereinafter.

The inductive head h₂ comprises the upper shield layer 167, a gap layer 174 laminated on the upper shield layer 167, a coil 176, an upper insulation layer 177 covering the coil 176, and an upper core layer 178 bonded to the gap layer 174 and bonded to the upper shield layer 167 at the coil 176 side.

The coil 176 is patterned to be a planar coil. A base end portion 178b of the upper core layer 178 are magnetically coupled with the lower core layer 167 at an approximately center of the coil 176.

A protective layer 179 comprising alumina is laminated on the upper core layer 178.

The Z-direction denotes the travel direction of the magnetic recording medium, the Y-direction denotes the direction of the leak magnetic field from the recording medium, and the X₁-direction denotes the direction toward the track width of the spin-valve type thin film magnetic element in FIGS. 1, 2 and 4.

The spin-valve type thin film magnetic element 1 shown in FIGS. 1 and 2 is a bottom type single spin-valve type thin film magnetic element comprising an antiferromagnetic layer 13, a pinned magnetic layer 14, a non-magnetic conductive layer 5 and a free magnetic layer 11 sequentially laminated in this order.

The reference numeral 164 denotes a lower gap layer formed of Al₂O₃, and the reference numeral 12 denotes a substrate layer made of Ta (tantalum) laminated on the insulation layer 164. An antiferromagnetic layer 13 is laminated on the substrate layer 12, a pinned magnetic layer 41 is laminated on the antiferromagnetic layer 13, a non-magnetic conductive layer 5 made of Cu is laminated on the pinned magnetic layer 41, a free magnetic layer 11 is laminated on the non-magnetic conductive layer 5, and a protective layer 20 made of Ta is laminated on the free magnetic layer 11.

A laminated body 21 having a width corresponding to the track width and an approximately trapezoidal cross section is constructed by sequentially laminating each layer of from the substrate layer 12 to the protective layer 20.

Bias layers 32 and 32 comprising, for example, a Co—Pt (cobalt-platinum) alloy are formed at both sides along the X₁-direction of the laminated body 21, or at both sides along the track width direction. The bias layers 32 and 32 aligns the direction of magnetization of the free magnetic layer 11 to reduce Barkhausen noises of the free magnetic layer 11.

The reference numerals 34 and 34 denotes conductive layers made of a metal such as Cr. Ta, Cu and Au. The conductive layers 34 and 34 are laminated above the bias layers 32 and 32. A sense current flows from these conductive layers 34 and 34 through the free magnetic layer 11.

A bias substrate layer 31 comprising Cr as a non-magnetic metal is provided between the bias layers 32 and the laminated body 21.

An intermediate layer 33 comprising Ta as a non-magnetic metal is provided between the bias layer 32 and the conductive layer 34.

The conductive layers 34 and 34 extends above the protective layer 20 exposed on the upper face of the laminated body 21, and is connected to the protective layer 20 via the intermediate layer 33.

It is preferable that the bias layers 32 and 32 are disposed at the same elevation as the free magnetic layer 11, and are formed with a larger film thickness than the film thickness of the free magnetic layer 11 toward the direction of the film thickness of the free magnetic layer 11. The upper faces 32a and 32a of the bias layers 32 and 32 are disposed at a position (upper side in FIG. 1.)—a distance apart from the lower gap layer 164 relative to the upper face 11a of the free magnetic layer 11. The lower faces of the bias layers 32 and 32 are disposed at a position (lower side in FIG. 1) to the lower gap layer 164 side relative to the lower face of the free magnetic layer 11.

Extending the conductive layers 34 and 34 above the protective layer 20 exposed on the surface of the laminated body 21 prohibits the sense current flowing from the conductive layers 34 and 34 to the laminated body 21 from flowing through the bias layers 32 and 32. Consequently, the proportion of the sense current directly flowing into the laminated body 21 without passing through the bias layers 32 and 32 may be increased. In addition, increasing the joint area between the laminated body 21 and the conductive layers 32 and 32 allows the direct current resistance (DCR) to be reduced to improve regenerative characteristics of the element.

It is also preferable that the joints between the upper faces 32a and 32a of the bias layers 32 and 32 and the side faces of the laminated body 21 are located at a lower gap layer 164 side relative to the upper face 11a of the free magnetic layer 11 on the side faces of the laminated body 21 (the lower side in FIG. 1), and at the lower side relative to the uppermost site (both side edges of the upper faces 32a and 32a of the bias layers 32 and 32 in FIG. 1) of the bias layers 32 and 32 at a distance apart from the laminated body 21.

Magnetic flux in the magnetic field applied from the bias layers 32 and 32 to the free magnetic layer 11 is easily controlled by the positional relations as described above. In other words, the effective magnetic field applied on the free magnetic layer 11 is seldom reduced by absorbing the leak magnetic flux from the bias layers 32 and 32 into the upper shield layer 167 located at the upper portion of the laminated body 21, or magnetic domains in the free magnetic layer 11 are scarcely distorted by the reversed magnetic field applying from the bias film adhered on the protective layer 20 as an over-ring to the end portion of the free magnetic layer 11. Consequently, the free magnetic layer 11 is easily put into a single domain state to enable magnetic domains of the free magnetic layer 11 to be readily controlled.

The antiferromagnetic layer 13 may be formed of an alloy represented by a formula X—Mn (wherein X denotes one element selected from Pt, Pd, Ru, Ir, Rh, and Os) or an alloy represented by a formula X′—Mn (wherein X′ represents one or plural elements represented by Pt, Pd, Cr, Ni, Ru, Ir, Rh, Os, Au, Ag, Ne, Ar, Xe and Kr). When the antiferromagnetic layer 13 is made of the alloy represented by the formulae above, deterioration of characteristics by air oxidation of the antiferromagnetic layer, or by diffusion of oxygen in the gap layers 164 and 166 provided on and under the spin-valve type thin film magnetic element 1 into the antiferromagnetic layer to be hardly caused.

The antiferromagnetic layer 13 is preferably formed of a PtMn alloy among the alloys represented by the formulae above. The PtMn alloy has a better corrosion resistance as compared with a NiMn alloy nad FeMn alloy that have been used as antiferromagnetic layers, besides having a high blocking temperature and exchange coupling magnetic field.

The PtMN alloy and the alloys represented by the formula of X—Mn preferably contain Pt or X in a range of 37 to 63 atomic percentage (at %). More preferably, the range is 44 to 57 at %. The alloys represented by the formula of X′—Mn preferably contain X′ in the range of 37 to 63 at %, more preferably in the range of 44 to 57 at %.

The antiferromagnetic layer 13 may comprise α-Fe₂O₃. The antiferromagnetic layer 13 comprising α-Fe₂O₃ has a higher blocking temperature where the exchange coupling magnetic field is extinguished, as well as a larger exchange coupling magnetic field (an exchange anisotropic magnetic field), as compared with the alloys comprising represented by the formula X—Mn or X′—Mn.

The antiferromagnetic layer 13 that generates a large exchange coupling magnetic field can be obtained by using an alloy having an appropriate composition range as described above, followed by heat treatment in a magnetic field. The PtMn alloy in particular affords an excellent antiferromagnetic layer 13 having an exchange coupling magnetic field of more than 64 kA/m, and a blocking temperature of as high as 380° C. where the exchange coupling magnetic field is extinguished.

While the alloy represented by the formula of X—Mn or the alloy represented by the formula of X′—Mn required a high annealing temperature, the annealing temperature of α-Fe₂O₃ is lower than the annealing temperature required in the alloy represented by the formula of X—Mn or X′—Mn. Accordingly, α-Fe₂O₃ may be used with annealing at a low temperature, or requires no annealing step.

It is preferable that the conductive layer 5 is formed of a non-magnetic material represented by Cu, Cr, Au and Ag, and Cu is most preferable.

The free magnetic layer 11 comprises a non-magnetic intermediate layer 9, and a first free magnetic layer 10 and a second free magnetic layer 8 facing across the non-magnetic intermediate layer 9 to one another as shown in FIGS. 1 and 2. The first free magnetic layer 10 is provided at the protective layer side 20 relative to the non-magnetic intermediate layer 9, and the second free magnetic layer 8 is provided at the non-magnetic conductive layer side 5 relative to the non-magnetic intermediate layer 9.

The second free magnetic layer 8 comprises a diffusion preventive layer 6 and a ferromagnetic layer 7.

Both of the first free magnetic layer (the first magnetic layer) 10 and the ferromagnetic layer (the second magnetic layer) 7 of the second free magnetic layer 8 are formed of a ferromagnetic material of NiFe alloy or Co. The first free magnetic layer 10 preferably made of the same material as the ferromagnetic layer 7.

Each of the first free magnetic layer 10 and the ferromagnetic layer 7 may comprise a NiFe alloy layer or a Co layer at least at the side in contact with the non-magnetic intermediate layer 9, and remaining portions of it may comprise a CoNiFe alloy, CoFe alloy, CoNi alloy, NiFe alloy or Co. The layers at the side in contact with at least the non-magnetic intermediate layer 9 of the first free magnetic layer 10 and the ferromagnetic layer 7 are made of the same material to one another.

It is preferable that the side of the second free magnetic layer 8 in contact with the non-magnetic conductive layer 5 comprises the Co layer.

The non-magnetic intermediate layer 9 is made of a non-magnetic material, preferably one of Ru, Cr, Ir and Rh.

The diffusion preventive layer 6 is made of a ferromagnetic material, for example Co. The diffusion preventive layer 6 prevents mutual diffusion between the ferromagnetic layer 7 and the non-magnetic conductive layer 5. The second free magnetic layer 8 may comprise a monolayer.

The constituting materials of the non-magnetic intermediate layer 9, its preferable thickness t₄, and the effect thereof, when each of the first free magnetic layer (the first magnetic layer) 10 and the ferromagnetic layer 7 comprises the NiFe layer at the side in contact with the non-magnetic intermediate layer 9, will be described in the cases (1) to (4) hereinafter.

The saturation magnetic field (Hₛ) as used herein refers to the magnitude of the external magnetic field that causes rotation of the direction of magnetization of one of the magnetic layer toward a direction by 180° different from the original direction of magnetization, when an external magnetic field parallel to the direction of magnetization of either the first free magnetic layer 10 or the ferromagnetic layer 7 is applied. In other words, the saturation magnetic field (Hₛ) refers to the magnitude of the magnetic field when the directions of magnetization of the first free magnetic layer 10 and the ferromagnetic layer 7 are parallel to one another.

The spin-flop magnetic field (H_{sf}) as used herein refers to the magnitude of the external magnetic field that causes spin-flop transition in the first free magnetic layer 10 and the ferromagnetic layer 7. Or, the spin-flop magnetic field (H_{sf}) refers to the magnitude of the external magnetic field that initiates collapse of an antiparallel relation between the two magnetic layers (the first free magnetic layer 10 and the ferromagnetic layer 7), or that initiate collapse of a perfect ferrimagnetic state, when an external magnetic field parallel to the direction of magnetization of either the first free magnetic layer 10 or the ferromagnetic layer 7 is applied.

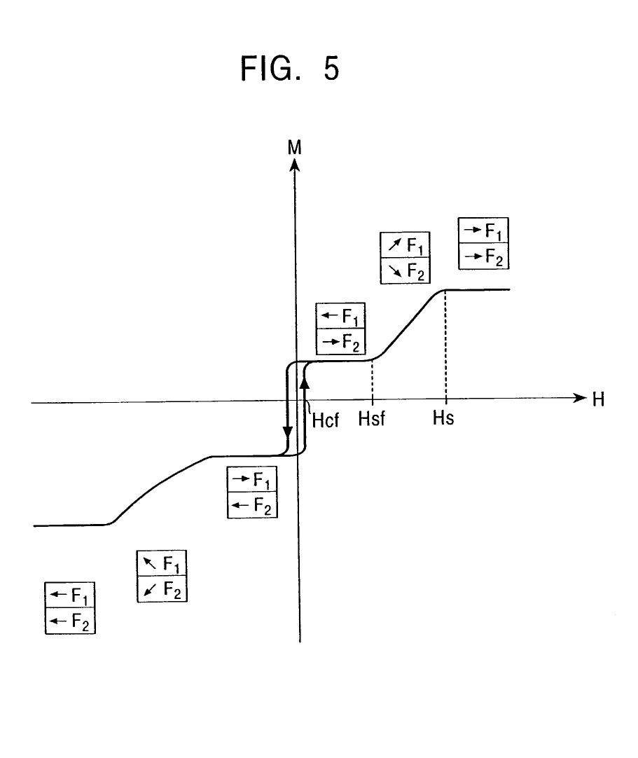

FIG. 5 shows a M-H curve of the free magnetic layer 11. This M-H curve shows the change of magnetization M of the free magnetic layer 11, when an external magnetic field H is applied to the free magnetic layer 11 having the construction as shown in FIG. 1 from the direction of the track width. The external magnetic field H corresponds to a bias magnetic field from the bias layer 32.

In FIG. 5, the arrow indicated by F₁ represents the direction of magnetization of the first free magnetic layer 10, and arrow indicated by F₂ in FIG. 5 represents the direction of magnetization of the second free magnetic layer 8.

As shown in FIG. 5, while the first free magnetic layer 10 and the second free magnetic layer 8 exhibits antiferromagnetic coupling to one another, or the directions of the arrows F1 and F2 are antiparallel to one another, when the external magnetic field H is small, such ferrimagnetic state cannot be maintained when the external magnetic field H exceeds a certain level. This phenomenon is called a spin-flop transition. The magnitude of the external magnetic field when the spin-flop transition appears corresponds to the spin-flop magnetic field, which is indicated by H_{sf} in FIG. 5. When the external magnetic field H is increased over the spin-flop magnetic field, F₁ turns to a direction by 180° different from the original direction, or both of F₁ and F₂ are parallel to one another by being saturated toward the direction of the applied magnetic field to completely collapse the ferrimagnetic state. This phenomenon is called as saturation magnetization, which is indicated by Hₛ in FIG. 5.

(1) When the non-magnetic intermediate layer comprises Ru:

t₄=0.27 to 1.03 nm →Hs>40 kA/m,

preferably

t₄=0.27 to 0.54 nm or

t₄=0.7 to 0.92 nm →Hs>40 kA/m,

or 0.32 to 1.03 nm →Hs>40 kA/m,

H_{sf}>4 kA/m,

preferably

t₄=0.32 to 0.49 nm or

or 0.65 to 1.03 nm →H_{sf}>16 kA/m,

more preferably

t₄=0.32 to 0.49 nm or

or 0.7 to 0.92 nm →Hₛ>80 kA/m,

H_{sf}>16 kA/m,

(2) When the non-magnetic intermediate layer comprises Cr:

t₄=0.97 to 1.16 nm →Hₛ>40 kA/m,

H_{sf}>4 kA/m,

(3) When the non-magnetic intermediate layer comprises Ir:

t₄=0.27 to 0.59 nm →Hₛ>80 kA/m,

preferably

t₄=0.32 to 0.59 nm →Hₛ>80 kA/m,

H_{sf}>16 kA/m,

(4) When the non-magnetic intermediate layer comprises Rh:

t₄=0.44 to 0.88 nm →Hₛ>80 kA/m,

t₄=0.55 to 0.83 nm

or 1.54 to 1.87 nm →H_{sf}>4 kA/m,

preferably

t₄=0.55 to 0.83 nm →Hₛ>80 kA/m,

H_{sf}>16 kA/m

The constituting materials of the non-magnetic intermediate layer 9, its preferable thickness t₄ and the effect thereof, when the Co layer is formed at the side where the first free magnetic layer (first magnetic layer) 10 and the ferromagnetic layer (second magnetic layer) 7 contact at least the non-magnetic intermediate layer-9, will be described in the cases of (5) to (8) below.

(5) When the non-magnetic intermediate layer comprises Ru:

t₄=0.38 to 1.03 nm →Hₛ>80 kA/m

H_{sf}>16 kA/m,

(6) When the non-magnetic intermediate layer comprises Cr:

t₄=0.87 to 1.46 nm →H_{sf}>40 kA/m

preferably

t₄=0.97 to 1.26 nm →Hₛ>80 kA/m

t₄=0.97 to 1.46 nm →Hₛ>40 kA/m

H_{sf}>4 kA/m,

more preferably

t₄=1.07 to 1.26 nm →Hₛ>80 kA/m

H_{sf}>16 kA/m,

(7) When the non-magnetic intermediate layer comprises Ir:

t₄=0.27 to 0.7 nm

or 1.3 to 1.62 nm →Hₛ>40 kA/m

preferably

t₄=0.27 to 0.7 nm →Hₛ>80 kA/m

more preferably

t₄=0.43 to 0.65 nm →Hₛ>80 kA/m

H_{sf}>16 kA/m

(8) When the non-magnetic intermediate layer comprises Rh:

t₄=0.44 to 0.99 nm,

or 1.54 to 1.98 nm →Hₛ>40 kA/m

preferably

t₄=0.44 to 0.99 nm →Hₛ>80 kA/m

The second free magnetic layer 8 is formed to have a larger thickness t₂ than the thickness t₁ of the first free magnetic layer 10.

The magnetic film thickness of the first free magnetic layer 10 and the second free magnetic layer 8 are represented by M₁·t₁ and M₂·t₂, respectively, when saturation magnetization of the first free magnetic layer 10 and the second free magnetic layer 8 are M₁ and M₂, respectively.

Since the second free magnetic layer 8 comprises the diffusion preventive layer 6 and ferromagnetic layer 7, the magnetic film thickness M₂·t₂ of the second free magnetic layer 8 is represented by a sum of the magnetic film thickness M₂₁·t₂₁ of the diffusion preventive layer 6 and the magnetic film thickness M₂₂·t₂₂ of the ferromagnetic layer 7, or by the following equation:

M₂·t₂=M₂₁·t₂₁+M₂₂·t₂₂

wherein M₂₁ and t₂₁ denote the saturation magnetization and film thickness of the diffusion preventive layer 6, respectively, and M₂₂ and t₂₂ denote the saturation magnetization and film thickness of the ferromagnetic layer 7.

The free magnetic layer 11 is formed so that the relation between the magnetic film thickness of the first free magnetic layer 10 and the magnetic film thickness of the second free magnetic layer 8 satisfies the relation of M₁·t₁>M₂·t₂.

The first free magnetic layer 10 and the second free magnetic layer 8 exhibit an antiferromagnetic coupling to one another. Or, when the direction of magnetization of the second free magnetic layer 8 is aligned along the X₁-direction by the bias layers 32 and 32, the direction of magnetization of the first free magnetic layer 10 is aligned toward the opposed direction to the X₁-direction.

Since the relation between the magnetic film thickness of the first free magnetic layer 10 and the magnetic film thickness of the second free magnetic layer 8 is represented by M₁·t₁>M₂·t₂, the second free magnetic layer 8 has remnant magnetization to align the direction of magnetization of the free magnetic layer 11 along the X₁-direction as a whole. The effective film thickness of the free magnetic layer 11 is represented by (M₂·t₂−M₁·t₁).

The first free magnetic layer 10 and the second free magnetic layer 8 are apparently put into a ferrimagnetic state, since the two layers exhibit an antiferromagnetic coupling to one another so that respective directions of magnetization are antiparallel to one another, and the each film thickness satisfies the relation of M₂·t₂>M₁·t₁.

Consequently, the direction of magnetization of the free magnetic layer intersects the direction of magnetization of the pinned magnetic layer 41.

Although the second free magnetic layer 8 and the first free magnetic layer 10 were allowed to be in a ferrimagnetic state to one another by adjusting the thickness t₂ of the second free magnetic layer 8 to be larger than the thickness t₁ of the first free magnetic layer 10 to satisfy the relation of M₂·t₂>M₁·t₁ between the magnetic film thickness of the first free magnetic layer 10 and the magnetic film thickness of the second free magnetic layer 8 in this embodiment, the ferrimagnetic state may be formed by adjusting the thickness t₁ of the first free magnetic layer 10 to be larger than the thickness t₂ of the second free magnetic layer 8.

When the direction of magnetization of the free magnetic layer aligned along the X₁-direction 11 fluctuates by the leak magnetic field from a recording medium such as a hard disk in this spin-valve type thin film magnetic element 1, electrical resistance changes in relation to magnetization of the pinned magnetic layer 41 pinned along the Y-direction as will be illustrated hereinafter. The leak magnetic field from the recording medium can be sensed by voltage changes based on the change of the electrical resistance.

The Hₛ value may be adjusted to be larger than 40 kA/m or the H_{sf} value may be adjusted to be larger than 4 kA/m, or the Hₛ value may be adjusted to be larger than 40 kA/m and the H_{sf} value may be adjusted to be larger than 4 kA/m in the free magnetic layer 11, particularly when the combinations of the constituting materials of the layer of the first free magnetic layer 10 of the free magnetic layer 11, and the layer of the layer of the ferromagnetic layer 7 at the side in contact with the non-magnetic intermediate layer 9, and the constituting material of the non-magnetic intermediate layer 9, and the thickness of the non-magnetic intermediate layer 9 in each combination, are determined to be within the range as described above.

When the magnitude of Hₛ of the free magnetic layer 11 is larger than 40 kA/m, the directions of magnetization of the first free magnetic layer 10 and ferromagnetic layer 7 constituting the free magnetic layer 11 are antiparallel to one another. In addition, since the magnitude of the spin-flop magnetic field (H_{sf}) that causes a magnetic transition in the first free magnetic layer 10 and ferromagnetic layer 7 can be increased, the antiferromagnetic coupling between the first free magnetic layer 10 and ferromagnetic layer 7 constituting the free magnetic layer 11 may be securely maintained to enhance sensitivity of the spin-valve type thin film magnetic element 1.

When the magnitude of H_{sf} of the free magnetic layer 11 is larger than 4 kA/m, the range where the ferrimagnetic state of the free magnetic layer 11 is maintained may be expanded. Accordingly, the antiferromagnetic coupling between the first free magnetic layer 10 and the ferromagnetic layer 7 constituting the free magnetic layer 11 may be more securely maintained to enhance sensitivity of the the spin-valve type thin film magnetic element.

The pinned magnetic layer 41 comprises the non-magnetic intermediate layer 43, and the first pinned magnetic layer 42 and the second pinned magnetic layer 44 facing across the non-magnetic intermediate layer 43 to one another. The first pinned magnetic layer 42 is provided at the antiferromagnetic layer 13 side relative to the non-magnetic intermediate layer 43 in contact with the antiferromagnetic layer 13, and the second pinned magnetic layer 44 is provided at the non-magnetic conductive layer 5 side relative to the non-magnetic intermediate layer 43 in contact with the non-magnetic conductive layer 5.

It is preferable that the thickness of the first pinned magnetic layer (the first magnetic layer) 42 is slightly different from the thickness of the non-magnetic intermediate layer 43 (the second magnetic layer). The thickness of the second pinned magnetic layer 44 is adjusted to be larger than the thickness of the first pinned magnetic layer 42 in FIGS. 1 and 2.

Both of the first and the second pinned magnetic layers 42 and 44 are formed of the same ferromagnetic material such as the NiFe alloy or Co.

Each of the first and second pinned magnetic layers 42 and 44 may comprise the NiFe alloy layer or Co layer at the side in contact with at least the non-magnetic intermediate layer 43, and the remaining portions may be formed of a CoNiFe alloy, CoFe alloy, CoNi alloy, NiFe alloy or Co. The sides of the first and second pinned magnetic layers 42 and 44 in contact with at least the non-magnetic intermediate layer 43 are formed of the same material.

The second pinned magnetic layer 44 has a Co layer at the side in contact with the non-magnetic conductive layer 5.

The non-magnetic intermediate layer 43 is preferably formed of a non-magnetic material such as one of Ru, Cr, Ir and Rh.

The constituting materials of the non-magnetic intermediate layer 43, preferable thickness t₃ and the effect thereof, when the first and second pinned magnetic layers 42 and 44 comprise a NiFe alloy layer in contact with at least the non-magnetic intermediate layer 43, will be described in the cases (9) and (12). The saturation magnetic field (Hₛ) as used herein refers to the magnitude of the external magnetic field that causes rotation of the direction of magnetization of one of the magnetic layer toward a direction by 180° different from the original direction of magnetization, when an external magnetic field parallel to the direction of magnetization of either one of the first and second pinned magnetic layers 42 and 44 is applied. In other words, the saturation magnetic field (Hₛ) refers to the magnitude of the magnetic field when the directions of magnetization of the first and second pinned magnetic layers 42 and 44 are parallel to one another. The spin-flop magnetic field (H_{sf}) as used herein refers to the magnitude of the magnetic field that causes spin-flop transition in the first and second pinned magnetic layers 42 and 44. Or, the spin-flop magnetic field (H_{sf}) refers to the magnitude of the magnetic field that initiates collapse of an antiparallel relation between the two magnetic layers (the first and second pinned magnetic layers), or that initiates collapse of a perfect ferrimagnetic state, when a magnetic field parallel to the direction of magnetization of one of the fist and second pinned magnetic layers 42 and 44 is applied.

(9) When the non-magnetic layer comprises Ru:

t₃=0.27 to 1.03 nm →Hₛ>40 kA/m

preferably

t₃=0.27 to 0.54 nm

or 0.7 to 0.92 nm →Hₛ>80 kA/m,

t₃=0.32 to 1.03 nm →Hₛ>40 kA/m

H_{sf}>4 kA/m,

preferably

t₃=0.32 to 0.49 nm

or 0.65 to 1.03 nm →H_{sf}>16 kA/m,

more preferably

t₃=0.32 to 0.49 nm

or 0.7 to 0.92 nm →Hₛ>80 kA/m

H_{sf}>16 kA/m

(10) When the non-magnetic layer comprises Cr:

t₃=0.97 to 1.16 nm →Hₛ>40 kA/m

H_{sf}>4 kA/m

(11) When the non-magnetic layer comprises Ir:

t₃=0.27 to 0.59 nm →Hₛ>80 kA/m,

preferably

t₃=0.32 to 0.59 nm →Hₛ>80 kA/m

H_{sf}>16 kA/m

(12) When the non-magnetic layer comprises Rh:

t₃=0.44 to 0.88 nm →Hₛ>80 kA/m,

t₃=0.55 to 0.83 nm

or 1.54 to 1.87 nm →H_{sf}>4 kA/m,

preferably

t₃=0.55 to 0.83 nm →Hₛ>80 kA/m

H_{sf}>16 kA/m

The constituting materials of the non-magnetic intermediate layer 43, preferable thickness t₃ and the effect thereof, when the first and second pinned magnetic layers 42 and 44 comprise a Co alloy layer making contact with at least the non-magnetic intermediate layer 43, will be described in the cases (13) and (16).

(13) When the non-magnetic intermediate layer comprises Ru:

t₃=0.38 to 1.03 nm →Hₛ>80 kA/m

H_{sf}>16 kA/m

(14) When the non-magnetic intermediate layer comprises Cr:

t₃=0.87 to 1.46 nm →Hₛ>40 kA/m,

preferably

t₃=0.97 to 1.26 nm →Hₛ>80 kA/m,

t₃=0.97 to 1.46 nm →Hₛ>40 kA/m

H_{sf}>4 kA/m,

more preferably

t₃=1.07 to 1.26 nm →Hₛ>80 kA/m

H_{sf}>16 kA/m

(15) When the non-magnetic intermediate layer comprises Ir:

t₃=0.27 to 0.7 nm

or 1.30 to 1.62 nm →Hₛ>40 kA/m,

preferably

t₃=0.27 to 0.7 nm →Hₛ>80 kA/m,

more preferably

t₃=0.43 to 0.65 nm →Hₛ>80 kA/m,

H_{sf}>16 kA/m

(16) When the non-magnetic intermediate layer comprises Rh:

t₃=0.44 to 0.99 nm

or 1.54 to 1.98 nm →Hₛ>40 kA/m,

preferably

t₃=0.44 to 0.99 nm →Hₛ>80 kA/m

The direction of magnetization of the first pinned magnetic layer 42 is fixed toward the Y-direction by the exchange coupling magnetic field with the antiferromagnetic layer 13, and the direction of magnetization of the second pinned magnetic layer 44 is fixed toward the Y-direction by the antiferromagnetic coupling with the first pinned magnetic layer 42.

The magnetic moments of the first and second pinned magnetic layers 42 and 44 are distinguished to one another due to an antiparallel relation between the directions of magnetization of the first and second pinned magnetic layers 42 and 44. However, since the thickness of the second pinned magnetic layer 44 is slightly larger, the pinned magnetic layer 41 itself has remnant spontaneous magnetization to permit the layer to be in a ferrimagnetic state. This spontaneous magnetization is amplified by the exchange coupling magnetic field with the antiferromagnetic layer 13 to fix the direction of magnetization of the pinned magnetic layer 41 toward the Y-direction.

The magnitude of Hₛ may be adjusted to be larger than 40 kA/m or the magnitude of H_{sf} may be adjusted to be larger than 4 kA/m, or the magnitude of Hₛ may be adjusted to be larger than 40 kA/m and the magnitude of H_{sf} may be adjusted to be larger than 4 kA/m in the free magnetic layer 11, particularly when the combinations of the constituting materials of the layers of the first and second pinned magnetic layers 42 and 43 in the pinned magnetic layer 41 at the side in contact with the non-magnetic intermediate layer 43, and the constituting materials of the non-magnetic intermediate layer 43, and the thickness of the non-magnetic intermediate layer 43 in each combination, are determined to be within the range as described above.

When the magnitude of Hₛ of the pinned magnetic layer 41 is increased, the directions of magnetization of the first and second pinned magnetic layers 42 and 44 constituting the pinned magnetic layer 41 turn out to be antiparallel to one another to permit the pinned magnetic layer to have a minute amount of remnant spontaneous magnetization, besides enabling the value of H_{sf} to be increased. Accordingly, the spontaneous magnetization is amplified by the exchange coupling magnetic field with the antiferromagnetic layer 13 to enable the direction of magnetization of the pinned magnetic layer to be securely fixed.

When the magnitude of H_{sf} of the is larger than 4 kA/m, the direction of magnetization of the pinned magnetic layer 41 can be also securely fixed, by expanding range of the magnetic field where the ferrimagnetic state is maintained.

The method for manufacturing the spin-valve type thin film magnetic element 1 according to this embodiment will be described below.

The method for manufacturing the spin-valve type thin film magnetic element 1 comprises a lamination step for forming a multilayer body, a first heat-treatment step for fixing the direction of magnetization of the pinned magnetic layer 41 by allowing an exchange coupling magnetic field to be generated at the interface between the antiferromagnetic layer 13 and pined magnetic layer 41 by applying a heat treatment in a magnetic field, and a second heat-treatment step for uniaxially aligning the direction of magnetization of the free magnetic layer 11 by applying a heat-treatment in a magnetic field.

Details of each step will be described hereinafter.

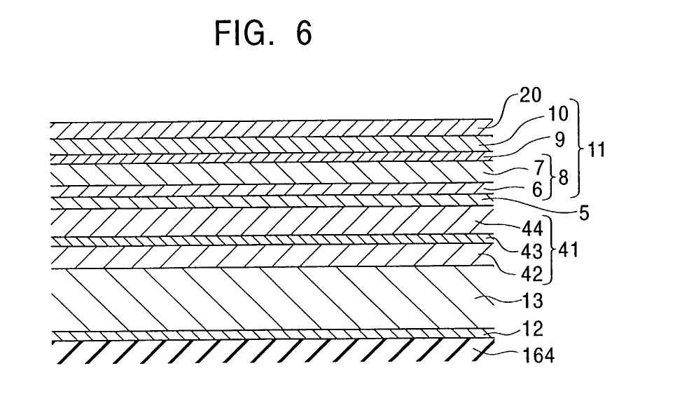

In the lamination step to be described at first, a multilayer body is formed by sequentially laminating the substrate layer 12, the antiferromagnetic layer 13, the first pinned magnetic layer 42, the non-magnetic intermediate layer 43, the second pinned magnetic layer 44, the non-magnetic conductive layer 5, the second free magnetic layer 8 comprising the diffusion preventive layer 6 and the ferromagnetic layer 7, the non-magnetic intermediate layer 9, the first free magnetic layer 10, and the protective layer 20 on the lower gap layer 164 as shown in FIG. 6.

The film thickness of the second pinned magnetic layer 44 is adjusted to be larger than the film thickness of the first pinned magnetic layer 42, and the film thickness t₃ of the non-magnetic intermediate layer 43 is adjusted to be within the range as hitherto described depending on the combination between the constituting materials of the non-magnetic intermediate layer and the constituting materials of the first and second pinned magnetic layers 42 and 44 in contact with the non-magnetic intermediate layer. In addition, the film thickness of the second free magnetic layer 8 is adjusted to be larger than the film thickness of the first free magnetic layer 10, and the film thickness t₄ of the non-magnetic intermediate layer 9 is adjusted within the range as hitherto described depending on the combination between the constituting material of the non-magnetic intermediate layer and the constituting material of the first free magnetic layer 10 and the ferromagnetic layer 7 in contact with the non-magnetic intermediate layer.

In the subsequent first heat-treatment step, the multilayer body is heat-treated while applying a magnetic field toward the direction perpendicular to the track width direction of the multilayer body to order the antiferromagnetic layer 13. As a result, an exchange coupling magnetic field is exhibited at the interface between the antiferromagnetic layer 13 and the pinned magnetic layer 41, thereby the direction of magnetization of the pinned magnetic layer 41 is fixed toward the direction perpendicular to the track width direction.

The antiferromagnetic layer 13 comprising a PtFe alloy is preferably heat-treated at a temperature within a range of 220 to 270° C. A high exchange coupling magnetic field may be generated by heat-treating at the temperature described above.

The magnitude of the magnetic field applied for heat-treatment is preferably 48 kA/m or more, more preferably 400 kA/m. It is preferable to apply the heat-treatment in an inert gas atmosphere or in vacuum.

A lift-off resist is formed on the multilayer body, and the both sides along the track width direction of the multilayer body is etched to form a laminated body 21 having an approximately trapezoid-shaped cross section. A bias substrate layer 31, a bias layer 32, an intermediate layer 33 and a conductive layer 34 are formed on both sides of the laminated body 21, thereby obtaining the spin-valve type thin film magnetic element 1.

Then, an upper gap layer 16, an upper shield layer 167, a gap layer 174, a coil (not shown), an upper insulation layer (not shown) and an upper core layer 178 as shown in FIG. 4 are sequentially laminated on the laminated body 21 and conductive layer 34. A thin film magnetic head h₁ comprising the spin-valve type thin film magnetic element 1, and an inductive head h₂ are formed as described above.

Subsequently, a second heat-treatment is applied in order to align the direction of inductive magnetic anisotropy of the free magnetic layer, which has been distorted by ordering heat treatment of the antiferromagnetic layer 13, toward the track width direction, by applying a heat treatment to the spin-valve type thin film magnetic element 1 while applying a magnetic field toward the track width direction.

The magnitude of the magnetic field applied in the step above is adjusted in a range larger than the coercive force (Hcf in FIG. 5) of the free magnetic layer 11, and smaller than the magnetic field that causes a spin-flop transition in the first and second magnetic layers 10 and 8.

An applied magnetic field smaller than the coercive force H_{cf} of the free magnetic layer 11 is not preferable, because the directions of inductive magnetic anisotropy of the free magnetic layers 10 and 8 cannot be aligned toward the track width direction to fail in diminishing Barkhausen noises of the free magnetic layer 11.

An applied magnetic field larger than the spin-flop magnetic field of the free magnetic layer 11 is also not preferable, because the directions of magnetization of the first and second free magnetic layers 10 and 8 cannot be aligned to be antiparallel to one another to fail in aligning the direction of inductive magnetic anisotropy toward the track width direction.

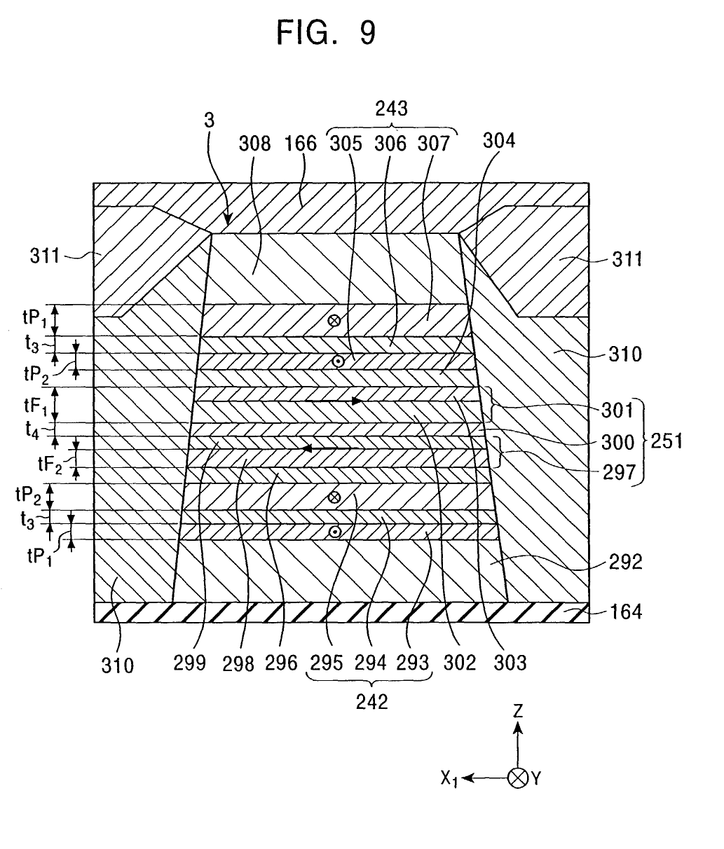

Applying the second heat-treatment step permits respective directions of inductive magnetic anisotropy of the first and second free magnetic layers 10 and 8, which have been distorted by the first heat-treatment step, to be aligned toward the track width direction (the X₁-direction) as shown in FIG. 9.

A third heat-treatment step may be applied after the second heat-treatment step. In the third heat-treatment step, the laminated body is heat-treated at a temperature lower than the temperature in the second heat-treatment step while applying a rotating magnetic field smaller than the spin-flop magnetic field. This third heat-treatment step allows magnetic hysteresis of the free magnetic layer 11 to be reduced, thereby to reduce the Barkhausen noise of the free magnetic layer 11.

It is not preferable that the magnitude of the magnetic field applied in the third heat-treatment step is smaller than the coercive force of the free magnetic layer 11, because magnetic hysteresis of the free magnetic layer 11 cannot be reduced. An applied magnetic field larger than the spin-flop magnetic field is not also preferable, because the directions of inductive magnetic anisotropy of the first and second free magnetic layers 10 and 8 are distorted to make it impossible to reduce the Barkhausen noise of the free magnetic layer 11.

A bias magnetic field is generated toward the track width direction by magnetizing the bias layers 32 and 32. The direction of magnetization of the second free magnetic layer 8 is aligned by this bias magnetic field, and the direction of magnetization of the first free magnetic layer 10 exhibiting antiferromagnetic coupling with the second free magnetic layer 8 is aligned toward the opposite direction to the direction of magnetization of the second free magnetic layer 8.

The first free magnetic layer 10 is brought into an antiferromagnetic coupling state with the second free magnetic layer 8 by the steps as described above, and the direction of magnetization of the free magnetic layer 11 is aligned toward the track width direction. Consequently, the spin-valve type thin film magnetic element 1 is obtained.

The thin film magnetic head h₁ comprising the spin-valve type thin film magnetic element 1 is able to sense a minute magnitude of external magnetic fields, enabling regenerative outputs voltage of the head to be large to allow it to be used in a magnetic recording device having a high recording density.

### Second Embodiment

The spin-valve type thin film magnetic head according to the second embodiment of the present invention will be described hereinafter.

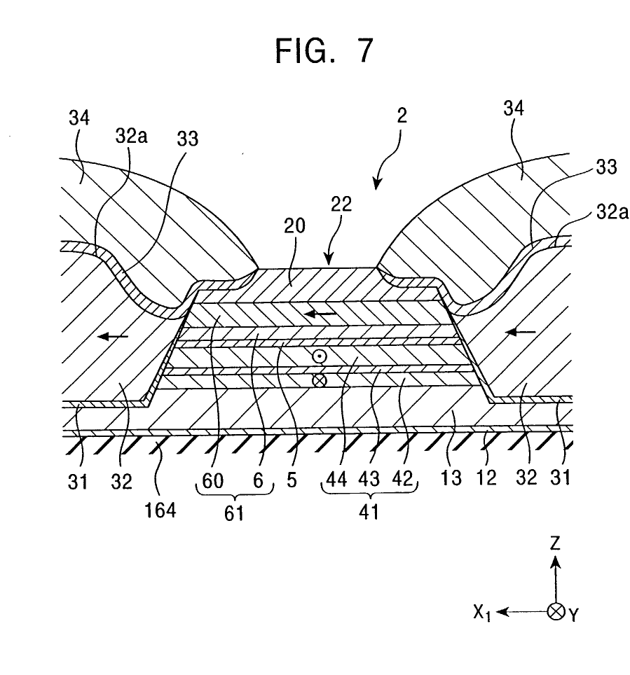

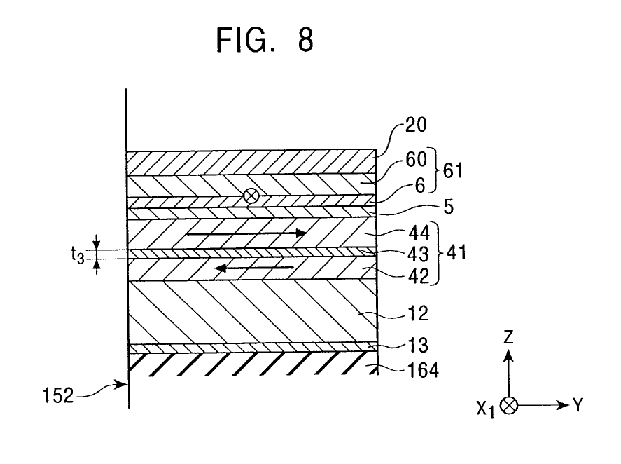

FIG. 7 illustrates a cross section of the spin-valve type thin film magnetic head as a second embodiment of the present invention viewed from the magnetic recording medium side, and FIG. 8 illustrates a cross section of the spin-valve type thin film magnetic head shown in FIG. 7 viewed from the track width side.

The same constituting elements as those shown in FIGS. 1 and 2 of the constituting elements shown in FIGS. 7 and 8 are given the same reference numerals as those in FIGS. 1 and 2, and their explanations are omitted, or abbreviated.

The Z-direction in FIGS. 7 and 8 denote the travel direction of the magnetic recording medium. The Y-direction denotes the direction of the leak magnetic field from the magnetic recording medium, and the X₁-direction denotes the track width direction of the spin-valve type thin layer magnetic element 2.

The spin-valve type thin layer magnetic element 2 shown in FIGS. 7 and 8 is mounted on the thin film magnetic head h₁ as in the spin-valve type thin layer magnetic element 1 of the first embodiment, and constitutes a floating type magnetic head.

The spin-valve type thin layer magnetic element 2 is a bottom type single spin-valve type thin film magnetic head comprising an antiferromagnetic layer 13, a pinned magnetic layer 41, a non-magnetic conductive layer 5 and a free magnetic layer 61 sequentially laminated in this order. The spin-valve type thin layer magnetic element 2 differs from the first spin-valve type thin layer magnetic element 1 shown in FIGS. 1 and 2 in that the free magnetic layer 61 comprises a ferromagnetic layer 60 and a diffusion preventive layer 6, the direction of magnetization of a first pinned magnetic layer 42 is fixed toward the Y-direction, and a second pinned magnetic layer 44 is fixed toward the opposite direction to the Y-direction by an exchange coupling magnetic field with the antiferromagnetic layer 13.

The ferromagnetic layer 60 of the free magnetic layer 61 is composed of a ferromagnetic material such as a CoNiFe alloy, a CoFe alloy, a CoNi alloy, a Nife alloy and Co. The diffusion preventive layer 6 is provided at the non-magnetic conductive layer 5 side.

The same constituting materials as used in the first embodiment are also used in the constituting materials of the first and second magnetic layers 42 and 44 of the pinned magnetic layer 41, and of the non-magnetic intermediate layer 43. The combinations of the constituting materials of the layer in contact with the non-magnetic intermediate layer 43 of the first and second magnetic layers 42 and 44 of the pinned magnetic layer 41, and the constituting materials of the non-magnetic intermediate layer 43, and the thickness of the non-magnetic intermediate layer 43 in each combination are the same as in the first embodiment.

A sense current flows through the free magnetic layer 6, the non-magnetic conductive layer 5 and the second pinned magnetic layer 44 from the conductive layers 34 and 34 in this spin-valve type thin film magnetic element 2. When a magnetic field is applied along the Y-direction as shown in FIGS. 7 and 8 by a leak magnetic field from a recording medium such as a hard disk, magnetization of the free magnetic layer 61 turns from the X₁-direction to the Y-direction. The electric resistance changes by spin-dependent scattering of conduction electrons at the interfaces between the non-magnetic conductive layer 5 and he free magnetic layer 61, and between the non-magnetic conductive layer 5 and the second pinned magnetic layer 14 to sense the leak magnetic field from the recording medium.

The magnitude of Hₛ of the pinned magnetic layer 41 may be adjusted to be larger than 40 kA/m or the magnitude of H_{sf} may be adjusted to be larger than 4 kA/m, or the magnitude of Hₛ may be adjusted to be larger than 40 kA/m while adjusting the magnitude of H_{sf} to be larger than 4 kA/m, particularly by determining the combinations of the constituting materials of the layer at the side in contact with the non-magnetic intermediate layer 43 of the first and second pinned magnetic layers 42 and 44 in the pinned magnetic layer 41, and the constituting materials of the non-magnetic intermediate layer 43, and the thickness of the non-magnetic intermediate layer 43 in each combination, within the same range as in the first embodiment.

It is possible to sense a minute magnitude of external magnetic fields using the thin film magnetic head h₁ comprising the spin-valve type thin film magnetic head 2 as described above with large regenerative out put voltages, enabling the magnetic head to be used in a magnetic recording device with a high recording density.

### Third Embodiment

The spin-valve type thin film magnetic element according to the third embodiment of the present invention will be described hereinafter.

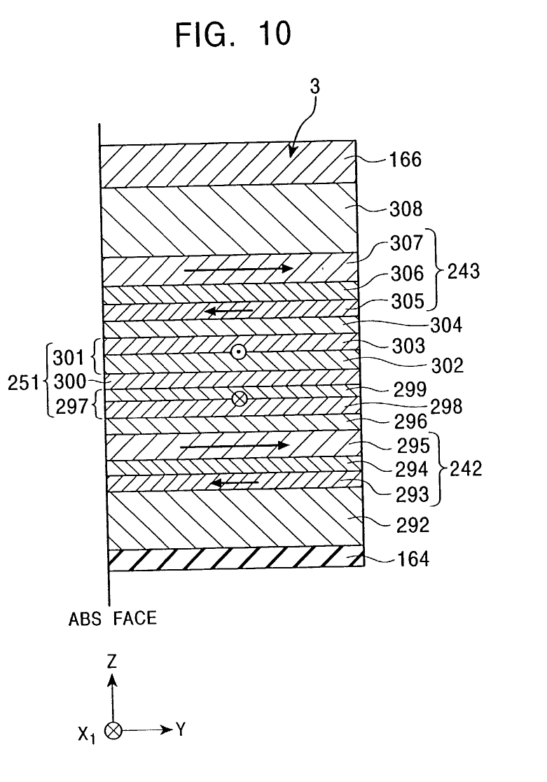

FIG. 9 illustrates a cross section of the spin-valve type thin film magnetic head as a third embodiment of the present invention viewed from the magnetic recording medium side, and FIG. 10 illustrates a cross section of the spin-valve type thin film magnetic head shown in FIG. 9 viewed from the track width side.

In FIGS. 9 and 10, the Z-direction denotes the travel direction of the magnetic recording medium, the Y-direction denotes the direction of the leak magnetic field from the magnetic recording medium, and the X₁-direction denotes the track width direction of the spin-valve type thin film magnetic element 3.

The spin-valve type thin film magnetic element 3 according to the third embodiment in FIGS. 9 and 10 constitutes a floating type magnetic head provided with a thin film magnetic head h₁ as in the spin-valve type thin film magnetic element 1 according to the first embodiment.

The spin-valve type thin film magnetic element 3 is a dual spin type spin-valve type thin film magnetic element comprising non-magnetic conductive layers 196 and 304 formed on and under a free magnetic layer 251 approximately at the center, pinned magnetic layers 242 and 243 formed on and under the non-magnetic conductive layers 196 and 304, respectively, and antiferromagnetic layers 292 and 308 on and under the pinned magnetic layers 242 and 243, respectively.

As shown in FIG. 9, bias layers 310 and 310 are formed at both sides of a laminated body from the antiferromagnetic layers 292 and 308, and conductive layers 311 and 311 are formed on the bias layers 310 and 310, respectively.

A free magnetic layer 251 is formed by being divided into a second free magnetic layer (second magnetic layer) 297 and a first free magnetic layer (first magnetic layer) 301 via a non-magnetic intermediate layer 300.

A pinned magnetic layer (lower) 242 under the free magnetic layer 251 is formed by being divided into a first pinned magnetic layer (first magnetic layer) 293 and a second pinned magnetic layer (second magnetic layer) 295 via a non-magnetic intermediate layer (lower) 294.

A pinned magnetic layer (upper) 243 on the upper side of the free magnetic layer 251 is formed by being divided into a second pinned magnetic layer (second magnetic layer) 305 and a first pinned magnetic layer (first magnetic layer) 307 via a non-magnetic intermediate layer (upper) 306.

The spin-valve type thin film element 3 is formed between the lower gap layer 164 and the upper gap layer 166.

The antiferromagnetic layer (lower) 292 is formed on the lower gap layer 164 in contact with the lower gap layer 164, and the first pinned magnetic layer (lower) 293, the non-magnetic intermediate layer (lower) 294, the second pinned magnetic layer (lower) 195, the non-magnetic conductive layer (lower) 296, the second free magnetic layer 297, the non-magnetic intermediate layer 300, the first free magnetic layer 301, the non-magnetic conductive layer (upper) 304, the second pinned magnetic layer (upper) 305, the non-magnetic intermediate layer (upper) 306, the first pinned magnetic layer (upper) 307 and the antiferromagnetic layer (upper) 408 are formed from the bottom in this order on the antiferromagnetic layer (lower) 292.

The antiferromagnetic layer (upper) 308 is made to contact the upper gap layer 166 comprising alumina formed thereon.

The material of each layer will be described below.

The antiferromagnetic layers 292 and 308 are preferably made of the same material as used in the antiferromagnetic layer 13 of the spin-valve type thin film magnetic element in the first embodiment such as an alloy represented by a formula of X—Mn, an alloy represented by a formula of X′—Mn, or α-Fe₂O₃.

The antiferromagnetic layer (upper) 308 preferably contains 37 to 63 at %, more preferably 44 to 57 at %, of Pt or X, when the layer comprises an alloy represented by the formula of PtMn or X—Mn. The antiferromagnetic layer (upper) also preferably contains 37 to 63 at %, more preferably 44 to 57 at %, of X when the layer comprises an alloy represented by the formula of X′—Mn.

The alloy represented by the formula of X—Mn, or by the formula of X′—Mn, may be desirably ordered into a fct structure by annealing after deposition by sputtering.

All of the first pinned magnetic layer (lower) 293, the first pinned magnetic layer (upper) 307, the second pinned magnetic layer (lower) 295, and the second pinned magnetic layer (upper) 305 are made of a ferromagnetic material such as a NiFe alloy or Co. It is preferable that all of the first pinned magnetic layer (lower) 293, the first pinned magnetic layer (upper) 307, the second pinned magnetic layer (lower) 295, and the second pinned magnetic layer (upper) 305 are made of the same material.

Each of the first pinned magnetic layer (lower) 293 and the second pinned magnetic layer (lower) 295 may have the NiFe layer or the Co layer at the side in contact with at least the non-magnetic intermediate layer (lower) 294, and the remaining portions may comprise the CoNiFe alloy, CoFe alloy, CoNi alloy, NiFe alloy or Co. The layer of the first pinned magnetic layer (lower) 293 and the second pinned magnetic layer (lower) 295 at the side in contact with at least the non-magnetic intermediate layer (lower) 294 are formed of the same material.

The first pinned magnetic layer (upper) 307 and the second pinned magnetic layer (upper) 305 may comprise the NiFe alloy or Co layer at the side in contact with at least the non-magnetic intermediate layer 306, and the remaining portions may be formed of the CoNiFe alloy, CoFe alloy, CoNi alloy, NiFe alloy or Co. The layer of the first pinned magnetic layer (upper) 307 and the second pinned magnetic layer (upper) 305 at the side in contact with at least the non-magnetic intermediate layer (upper) is formed of the same material.

The side of the second pinned magnetic layer (lower) 295 in contact with the non-magnetic conductive layer (lower) 296, and the side of the second pinned magnetic layer (upper) 305 in contact with the non-magnetic conductive layer (upper) 304 preferably comprise the Co layer.

The non-magnetic intermediate layer (lower) 294 and the non-magnetic intermediate layer (upper) 306 preferably comprise a non-magnetic material such as one of Ru, Cr, Ir and Rh.

The non-magnetic conductive layer (lower) Z96 and the non-magnetic conductive layer (upper) 304 preferably comprise a non-magnetic material represented by Cu, Cr, Au and Ag, and Cu is particularly preferable for forming these layers.

Each of the first free magnetic layer 301 and the second free magnetic layer 297 is formed into two layers.

The layers 302 and 299 of the first and the second free magnetic layers 301 and 297 formed via the non-magnetic intermediate layer 300, respectively, are made of a ferromagnetic material such as the NiFe alloy or Co.

It is preferable that the layers 302 and 299 of the first and the second free magnetic layers 301 and 297, respectively, are made of the same material to one another.

The layers 302 and 299 of the first and the second free magnetic layers 301 and 297, respectively, may comprise the NiFe alloy or the Co layer at the side in contact with at least the non-magnetic intermediate layer 300, and the remaining portions may be formed of the CoNiFe alloy, CoFe alloy, CoNi alloy, NiFe alloy or Co. The layers of the layers 302 and 299 of the first and the second free magnetic layers 301 and 297, respectively, in contact with at least the non-magnetic intermediate layer 300 are formed of the same material to one another.

The layers 298 of the second free magnetic layer 297 formed at the side in contact with the non-magnetic intermediate layer (lower) 296, and the layer 303 of the first free magnetic layer 301 formed at the side in contact with the non-magnetic conductive layer (upper) 304 are preferably made of Co. Forming the layers 298 and 303 at the sides in contact with the non-magnetic conductive layers 296 and 304, respectively, with the Co film permits the ΔMR to be large while preventing diffusion to the non-magnetic conductive layers 296 and 304.

An antiferromagnetic material for applying an annealing treatment is used as the antiferromagnetic layer (lower) 292 and the antiferromagnetic layer (upper) 308 in this embodiment, in order to generate an exchange coupling magnetic field (an exchange anisotropic magnetic field) at the interface between the first pinned magnetic layer (lower) 293 and the first pinned magnetic field (upper) 307.

However, since metallic elements are liable to be diffused at the interface between the antiferromagnetic layer (lower) 292 and the first pinned magnetic layer (lower) 293 formed below the free magnetic layer 251 to readily form a heat diffusion layer, the magnetic film thickness of the layer that functions as the first pinned magnetic layer (lower) 293 is made to be thinner than the actual film thickness tP₁.

Accordingly, it is preferable that the ratio of (the film thickness tP₁ of the first pinned magnetic layer (lower) 293/the film thickness tP₂ of the second pinned magnetic layer (lower) 295) of the layers formed below the free magnetic layer 251 is larger than the ratio of (the film thickness tP₁ of the first pinned magnetic layer (upper) 307/the film thickness tP₂ of the second pinned magnetic layer (upper) 305) of the layers formed above the free magnetic layer 251, in order to approximately equal the exchange coupling magnetic field generated at the laminated films above the free magnetic layer 251 to the exchange magnetic field generated from the laminated films below the free magnetic layer 251. Allowing the exchange coupling magnetic field generated at the laminated films above the free magnetic layer 251 to be equal to the exchange magnetic field generated from the laminated films below the free magnetic layer 251 enables the exchange coupling magnetic field to be less reduced in the manufacturing process, thereby improving reliability of the magnetic head.

Magnetization of the second pinned magnetic layer (lower) 295 and the second pinned magnetic layer (upper) 305 formed on and under the free magnetic layer 251, respectively, should be directed toward the opposite directions to one another in the dual spin-valve type thin film magnetic head 3 shown in FIGS. 9 and 10. This is because the free magnetic layer 251 is divided into the two layers of the first and the second free magnetic layers 301 and 297, and magnetization of the first free magnetic layer 301 and magnetization of the second free magnetic layer 297 are antiparallel to one another.

For example, when the first free magnetic layer 301 is magnetized toward the opposite direction tQ the X₁-direction as shown in FIGS. 9 and 10, the second free magnetic layer 297 is magnetized toward the X₁-direction by the exchange coupling magnetic field (RKKY interaction) with the first free magnetic layer 301. Magnetization of the first free magnetic layer 301 and the second free magnetic layer 297 are reversed to one another by being affected by the external magnetic field while maintaining a ferrimagnetic state.

Both of the magnetization of the first free magnetic layer 301 and magnetization of the second free magnetic layer 297 serve as the layers relating to ΔMR in the dual spin-valve type thin film magnetic element 3 shown in FIGS. 9 and 10. Electrical resistance changes depending on the relation between variable magnetization of the first free magnetic layer 301 and the second free magnetic layer 297, and pinned magnetization of the second pinned magnetic layer (lower) 295 and the second pinned magnetic layer (upper) 305. For allowing the function as the dual spin-valve type thin film magnetic element that may be expected to have a larger ΔMR as compared with the single spin-valve type thin film magnetic element to be exhibited, the directions of magnetization of the second pinned magnetic layer (lower) 295 and the second pinned magnetic layer (upper) 305 should be controlled so that resistance changes of the first free magnetic layer 301 and second pinned magnetic layer (upper) 305 exhibit the same variation behavior as resistance changes of the second free magnetic layer 297 and the second pinned magnetic layer (lower) 295. In other words, resistance changes of the second free magnetic layer 297 and the second pinned magnetic layer (lower) 295 are maximum when resistance changes of the first free magnetic layer 301 and the second pinned magnetic layer (upper) 305 are maximum, and resistance changes of the second free magnetic layer 297 and the second pinned magnetic layer (lower) 295 are minimum when resistance changes of the first free magnetic layer 301 and the second pinned magnetic layer (upper) 305 are minimum.

Accordingly, since the first free magnetic layer 301 and the second free magnetic layer 297 are magnetized to be antiparallel to one another in the dual spin-valve type thin film magnetic element 3 shown in FIGS. 9 and 10, the second pinned magnetic layer (upper) 305 and the second pinned magnetic layer (lower) 295 should be magnetized to the opposite directions to one another.

A sufficient ΔMR may be obtained by magnetizing the second pinned magnetic layer (lower) 295 and the second pinned magnetic layer (upper) 305 formed on and under the free magnetic layer, respectively, to the opposite directions to one another as described above.

Not only the pinned magnetic layers 242 and 243, but also the free magnetic layer 151 are divided into the first and second magnetic layers via the non-magnetic intermediate layers in the dual spin-valve type thin film magnetic element 3 shown in FIGS. 9 and 10. Magnetization of the first free magnetic layer 301 and magnetization of the second free magnetic layer 279 can be sensitively reversed against the external magnetic field, by bringing magnetization of the two magnetic layers to be antiparallel to one another (or bringing into a ferrimagnetic state) by the exchange coupling magnetic field (RKKY interaction) generated between the two layers.

When the first pinned magnetic layer (lower) 293 and the second pinned magnetic layer (lower) 295 comprise the NiFe alloy layer at the side in contact with at least the non-magnetic intermediate layer (lower) 194 in this embodiment, the constituting materials and preferable thickness t₃ of the non-magnetic intermediate layer (lower) 294 are determined to be the same as those in the cases (9) to (12) described in the first embodiment. The effects are the same as those in the cases (9) to (12) described in the first embodiment.

The constituting materials and preferable thickness t₃ of the non-magnetic intermediate layer (upper) 306 are also determined to be the same as those in the cases (9) to (12) described in the first embodiment, when the first pinned magnetic layer (upper) 307 and the second pinned magnetic layer (upper) 305 comprise the NiFe alloy layer at the side in contact with at least the non-magnetic intermediate layer (upper) 306. The effects are the same as those in the cases (9) to (12) described in the first embodiment.

Also, the constituting materials and preferable thickness t₃ of the non-magnetic intermediate layer (lower) 294 are determined to be the same as those in the cases (13) to (16) described in the first embodiment, when the first pinned magnetic layer (lower) 293 and the second pinned magnetic layer (lower) 295 comprise the Co layer at the side in contact with at least the non-magnetic intermediate layer (lower) 294. The effects are the same as those in the cases (13) to (16) described in the first embodiment.

Also, the constituting materials and preferable thickness t₃ of the non-magnetic intermediate layer (upper) 306 are determined to be the same as those in the cases (13) to (16) described in the first embodiment, when the first pinned magnetic layer (upper) 307 and the second pinned magnetic layer (upper) 305 comprise the Co layer at the side in contact with at least the non-magnetic intermediate layer (upper) 306. The effects are the same as those in the cases (13) to (16) described in the first embodiment.

Also, the constituting materials and preferable thickness t₃ of the non-magnetic intermediate layer (lower) 294 are determined to be the same as those in the cases (13) to (16) described in the first embodiment, when the first pinned magnetic layer (lower) 293 and the second pinned magnetic layer (lower) 295 comprise the Co layer at the side in contact with at least the non-magnetic intermediate layer (lower) 294. The effects are the same as those in the cases (13) to (16) described in the first embodiment.

Also, the constituting materials and preferable thickness t₃ of the non-magnetic intermediate layer (upper) 306 are determined to be the same as those in the cases (13) to (16) described in the first embodiment, when the first pinned magnetic layer (upper) 307 and the second pinned magnetic layer (upper) 305 comprise the Co layer at the side in contact with at least the non-magnetic intermediate layer (upper) 306. The effects are the same as those in the cases (13) to (16) described in the first embodiment.

Also, the constituting materials and preferable thickness t₄ of the non-magnetic intermediate layer 300 are determined to be the same as those in the cases (1) to (4) described in the first embodiment, when the layer 302 of the first free magnetic layer 301, and the layer 299 of the second free magnetic layer 297 comprise the NiFe layer at the side in contact with at least the non-magnetic intermediate layer 300. The effects are the same as those in the cases (1) to (4) described in the first embodiment.

Also, the constituting materials and preferable thickness t₄ of the non-magnetic intermediate layer 300 are determined to be the same as those in the cases (5) to (8) described in the first embodiment, when the layer 302 of the first free magnetic layer 301, and the layer 299 of the second free magnetic layer 297 comprise the Co layer at the side in contact with at least the non-magnetic intermediate layer 300. The effects are the same as those in the cases (1) to (8) described in the first embodiment.

The exchange coupling magnetic field may be increased by appropriately adjusting the film thickness ratio between the first free magnetic layer 301 and the second free magnetic layer 297, and the film thickness of the non-magnetic intermediate layer 300 inserted between the first free magnetic layer 301 and the second free magnetic layer 297; or the film thickness ratio between the first pinned magnetic layer 293 and the second pinned magnetic layer 295, and the film thickness of the non-magnetic intermediate layer 294 inserted between these layers; or the film thickness ratio between the first pinned magnetic layer 307 and the second pinned magnetic layer 305, and the film thickness of the non-magnetic intermediate layer 306 inserted between these layers; and the film thickness of the antiferromagnetic layers 292 and 308 within an appropriate range in the dual spin-valve type thin film magnetic element according to this embodiment. A thermally stable ferrimagnetic state may be maintained besides enabling to obtain sufficient ΔMR, by allowing the magnetization of the first and second pinned magnetic layers to be fixed while allowing magnetization of the first and second free magnetic layers to be variable.

The antiparallel relation between the first and second pinned magnetic layers (a ferrimagnetic state) can be more securely maintained by adjusting the direction of the sense current in this embodiment.

In the spin-valve type thin film magnetic element according to this embodiment, the bias layers 310 and 310 comprising a non-magnetic metal such as Cr are formed at both sides of the laminated body, in which the non-magnetic conductive layers 296 and 304, pinned magnetic layers 242 and 243, and the antiferromagnetic layers 292 and 308 are laminated, respectively, on and under the free magnetic layer 251 at the center. The conductive layers 311 and 311 comprising Cr, Ta, Cu or Au are formed on and under the laminated body, respectively, and a sense current flows through these conductive layers 311 and 311.

The sense current mainly flows through the interfaces between the non-magnetic conductive layers 296 and 304 having a small resistivity, and the nonmagnetic conductive layer (lower) 296 and the pinned magnetic layer (lower) 242, the interface between the non-magnetic conductive layer (upper) 304 and the pinned magnetic layer (upper) 243, the interface between the non-magnetic conductive layer (lower) 296 and free magnetic layer 251, and the interface between the non-magnetic conductive layer (upper) 304 and the free magnetic layer 251.

While the pinned magnetic layers 242 and 243 are divided into the first pinned magnetic layer and the second pinned magnetic layer in this embodiment, respectively, the sense current mainly flows through the interface between the second pinned magnetic layer and the non-magnetic conductive layer.

A sense current magnetic field is formed by the corkscrew rule by flowing the sense current. The flow direction of the sense current is adjusted in this embodiment, so that the magnetic moment of the sense current magnetic field is directed toward the same direction as the synthetic magnetic moment determined as a sum of the magnetic moment of the first pinned magnetic layer and the magnetic moment of the second pinned magnetic layer.

The magnitude of Hₛ or the magnitude of H_{sf} of the free magnetic layer 251 may be adjusted to be larger than 40 kA/m or 4 kA/m, respectively, or the magnitude of Hₛ and the magnitude of H_{sf} may be adjusted to be larger than 40 kA/m and 4 kA/m, respectively, in this embodiment, particularly when the combination between the constituting materials of the layers at the side where the first free magnetic layer 301 and second free magnetic layer 297 of the free magnetic field 151 contact the non-magnetic intermediate layer 300, and the constituting materials of the non-magnetic intermediate layer 300, and the thickness of the non-magnetic intermediate layer 300 in each combination fall within the foregoing range.

When the magnitude of Hₛ of the free magnetic field 251 is larger than 40 kA/m, the directions of magnetization of the first and second free magnetic layers 301 and 297 constituting the free magnetic layer 251 are antiparallel to one another, and the magnitude of the spin-flop magnetic field (H_{sf}) that causes a spin-flop transition in the first and second free magnetic layers 301 and 297 may be increased. Consequently, antiferromagnetic coupling between the first and second free magnetic layers 301 and 297 constituting the free magnetic layer 251 may be securely maintained to enable sensitivity of the spin-valve type thin film magnetic element 3 to be enhanced.

When the magnitude of H_{sf} of the free magnetic layer 251 is larger than 4 kA/m, the range where ferrimagnetic state of the free magnetic layer 251 is maintained may be expanded to enable antiferromagnetic coupling between the first and second free magnetic layers 301 and 297 constituting the free magnetic layer 251 to be more securely maintained, thereby enabling sensitivity of the spin-valve type thin film magnetic element to be more enhanced.

The magnitude of Hₛ or the magnitude of H_{sf} of the pinned magnetic layers 242 and 243 may be adjusted to be larger than 40 kA/m or 4 kA/m, respectively, or the magnitude of Hₛ and the magnitude of H_{sf} may be adjusted to be larger than 40 kA/m and 4 kA/m, respectively, particularly when the combination between the constituting materials of the layers at the side where the first and second pinned magnetic layers 193 and 295 of the pinned magnetic layer (lower) 242 contact the non-magnetic intermediate layer 294, and the constituting materials of the non-magnetic intermediate layer 294, and the thickness of the non-magnetic intermediate layer 294 in each combination fall within the foregoing range, and when the combination between the constituting materials of the layers at the side where the first and second pinned magnetic layers 307 and 305 of the pinned magnetic layer (upper) 243 contact the non-magnetic intermediate layer 306, and the constituting materials of the non-magnetic intermediate layer 306, and the thickness of the non-magnetic intermediate layer 306 in each combination fall within the foregoing range.

When the magnitude of Hₛ of each pinned magnetic layer is larger than 40 kA/m, the directions of magnetization of the first and second pinned magnetic layers constituting each magnetic layer are antiparallel to one another to give a minute magnitude of remnant spontaneous magnetization while increasing the magnitude of H_{sf}. Consequently, the spontaneous magnetization is amplified by an exchange coupling magnetic field with the antiferromagnetic layer in contact with each pinned magnetic layer, thereby enabling the direction of magnetization of each pinned magnetic layer to be securely fixed.

When the magnitude of H_{sf} is larger than 4 kA/m, the range of the magnetic field where ferrimagnetic state is maintained may be expanded to securely fix the direction of magnetization of each pinned magnetic layer.

The thin film magnetic head h₁ comprising the spin-valve type thin film magnetic head 3 is able to sense a minute magnitude of the external magnetic field with an increased regenerative output of the head, making it possible to used the magnetic head in a magnetic recording device with a high recording density.

### Fourth Embodiment

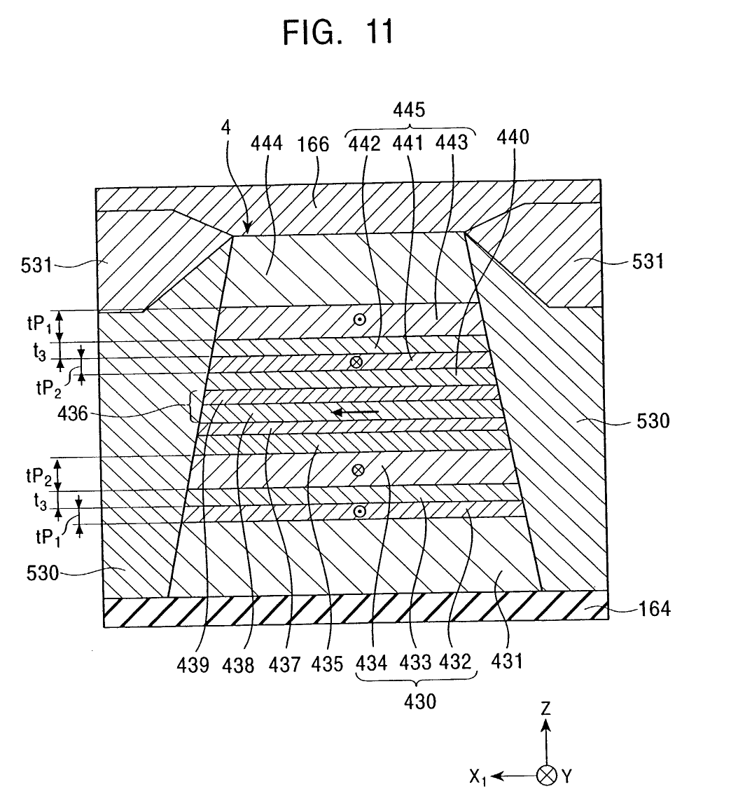

FIG. 11 illustrates a cross section of the spin-valve type thin film magnetic head as a fourth embodiment of the present invention viewed from the magnetic recording medium side, and FIG. 12 illustrates a cross section of the spin-valve type thin film magnetic head shown in FIG. 11 viewed from the track width side.

In FIGS. 11 and 12, the Z-direction is the travel direction of the magnetic recording medium, the Y-direction is the direction of the leak magnetic field from the magnetic recording medium, and the X₁-direction is the track width direction of the spin-valve type thin film magnetic element 4.

The spin-valve type thin film magnetic element 4 shown in FIGS. 11 and 12 constitutes a floating type magnetic head by being mounted on the thin film magnetic head H₁ as in the spin-valve type thin film magnetic element 1 in the first embodiment.

The spin-valve type thin film magnetic element 4 in this embodiment is a so-called dual spin-valve type thin film magnetic element in which non-magnetic conductive layers 435 and 440 are formed on and under a free magnetic layer 436 at the center, respectively, pinned magnetic layers 430 and 445 are formed on and under the non-magnetic conductive layers, respectively, and antiferromagnetic layers 431 and 444 are formed on and under the pinned magnetic layers, respectively.

As shown in FIG. 11, bias layers 530 and 530 are formed at both sides of the laminated body from the antiferromagnetic layer 431 through the antiferromagnetic layer 444, and conductive layers 531 and 531 are formed over and under the laminated body, respectively.

Since two pair of combinations of three layers of the free magnetic layer/non-magnetic conductive layer/pinned magnetic layer are formed in this dual spin-valve type thin film magnetic element 4, a larger magnitude of ΔMR than that of the single spin-valve type thin film magnetic element may be expected, thereby allowing the magnetic element to comply with high density recording.

The pinned magnetic layer (lower) 430 under the free magnetic layer 436 is divided into two layers of the first pinned magnetic layer (first magnetic layer) 432 and the second pinned magnetic layer (second magnetic layer) 434 via the non-magnetic intermediate layer (lower) 433.

The pinned magnetic layer (upper) 445 above the free magnetic layer 436 is divided into two layers of the second pinned magnetic layer (second magnetic layer) 441 and the first pinned magnetic layer (first magnetic layer) 443 via the non-magnetic intermediate layer (upper) 442.

The spin-valve type thin film magnetic element 4 is formed between a lower gap layer 164 and an upper gap layer 166.

The antiferromagnetic layer (lower) 431, the first pinned magnetic layer (lower) 432, the non-magnetic intermediate layer 433, the second pinned magnetic layer (lower) 434, non-magnetic conductive layer (lower) 435, the free magnetic layer 436 (the reference numerals 437 and 439 denote Co films, and the reference numeral 438 denotes a NiFe film), the non-magnetic conductive layer 440, the second pinned magnetic layer (upper) 441, the non-magnetic intermediate layer (upper) 442, the first pinned magnetic layer (upper) 443, and the antiferromagnetic layer (upper) 444 are laminated on the lower gap layer 164 in this order. The antiferromagnetic layer (upper) 444 are formed to be in contact with the upper gap layer 166 formed thereon.

The antiferromagnetic layer 431 is made of the same material as used in the antiferromagnetic layer 292 in the spin-valve type thin film magnetic element 3 in the third embodiment. The antiferromagnetic layer 444 is made of the same material as used in the antiferromagnetic layer 308 in the spin-valve type thin film magnetic element 3 in the third embodiment.

All of the first pinned magnetic layer (lower) 432 and the first pinned magnetic layer (upper) 443, and the second pinned magnetic layer (lower) 434 and the second pinned magnetic layer (upper) 441 are made of a ferromagnetic material such as a NiFe alloy or Co. The first pinned magnetic layer (lower) 432 and the first pinned magnetic layer (upper) 443, and the second pinned magnetic layer (lower) 434 and the second pinned magnetic layer (upper) 441 are preferably made of the same material.

The first pinned magnetic layer (lower) 432 and the second pinned magnetic layer (lower) 434 may comprise the NiFe alloy or Co layer at the side at least in contact with the non-magnetic intermediate layer (lower) 433, and the remaining portions may comprise a CoNiFe alloy, CoFe alloy, CoNi alloy, NiFe alloy and Co. The layers of the first pinned magnetic layer (lower) 432 and the second pinned magnetic layer (lower) 434 in contact with the non-magnetic intermediate layer (lower) 433 are made of the same material.

The first pinned magnetic layer (upper) 443 and the second pinned magnetic layer (upper) 441 may comprise the NiFe alloy or Co layer at the side in contact with at least the non-magnetic intermediate layer (upper) 442, and the remaining portions may be formed of the CoNiFe alloy, CoFe alloy, CoNi alloy, NiFe alloy and Co. The layers of the first pinned magnetic layer (upper) 443 and the second pinned magnetic layer (upper) 441 in contact with at least the non-magnetic intermediate layer (upper) 442 may be formed of the same material.

It is preferable that the side of the second pinned magnetic layer (lower) 434 in contact with the non-magnetic conductive layer (lower) 435, and the side of the second pinned magnetic layer (upper) 441 in contact with the non-magnetic conductive layer (upper) 440 comprise the Co layer.

The non-magnetic intermediate layer (lower) 433 and the non-magnetic intermediate layer (upper) 442 are preferably made of a non-magnetic material including one of the Ru, Cr, Ir and Rh.

The non-magnetic conductive layer (lower) 435 and the non-magnetic conductive layer (upper) 440 are preferably made of a non-magnetic material represented by Cu, Cr, Au and Ag, particularly made of Co.

As shown in FIGS. 11 and 12, the film thickness of tP₁ of the first pinned magnetic layer (lower) 432 formed below the free magnetic layer 436 is made to be thinner than the film thickness tP₂ of the second pinned magnetic layer (lower) 434 formed via the non-magnetic intermediate layer (lower) 433. On the other hand, the film thickness tP₁ of the first pinned magnetic layer (upper) 443 formed above the free magnetic layer 436 is made to be thicker than the film thickness tP₂ of the second pinned magnetic layer (upper) 441 formed via the non-magnetic intermediate layer 442. The first pinned magnetic layer (lower) 432 and the first pinned magnetic layer (upper) 443 are magnetized toward the opposite direction to the Y-direction, and the second pinned magnetic layer (lower) 434 and the second pinned magnetic layer (upper) 441 are magnetized toward the Y-direction.

In the dual spin-valve type thin film magnetic element 4 shown in FIGS. 10 and 11, the first pinned magnetic layer (lower) 432 and the first pinned magnetic layer (upper) 443 should be magnetized toward the same direction to one another. Therefore, the magnetic element may sufficiently function as the dual spin-valve type thin film magnetic element in this embodiment by allowing the magnetic moment Ms tP₁ of the first pinned magnetic element (lower) 432 and the first pinned magnetic element (upper) 443 to align with the magnetic moment Ms tP₂ of the second pinned magnetic element (lower) 434 and the second pinned magnetic element (upper) 441, and by appropriately adjusting the magnitude and direction of the magnetic field applied during the heat-treatment.

The first pinned magnetic layers 432 and 443 are magnetized toward the same direction to one another, in order to magnetize the second pinned magnetic layers 434 and 441, which are magnetized to be antiparallel to the first pinned magnetic layers 432 and 443, toward the same direction to one another. The reason will be described below.

The magnitude of ΔMR of the spin-valve type thin film magnetic element depends on the relation between the pinned magnetization of the pinned magnetic layer and the variable magnetization of the free magnetic layer. When the pinned magnetic layer is divided into the two layers of the first pinned magnetic layer and the second pinned magnetic layer as in this embodiment, the layer of the pinned magnetic layers directly related to the magnitude of ΔMR is the second pinned magnetic layer, and the first pinned magnetic layer serves as an auxiliary layer for fixing the second pinned magnetic layer toward a given direction.

Electrical resistance turns out to be very small in the relation between the pinned magnetization of the second pinned magnetic layer (lower) 434 and the variable magnetization of the free magnetic layer 436, even when the electrical resistance increases in the relation, for example, between the pinned magnetization of second pinned magnetic layer (upper) 441 and the variable magnetization of the free magnetic layer 436, provided that the second pinned magnetic layers 434 and 441 are magnetized toward the opposite directions to one another as shown in FIGS. 11 and 12. As a result, the magnitude of ΔMR in the dual spin-valve type thin film magnetic element turns out to be smaller than the magnitude of ΔMR in the single spin-valve type thin film magnetic element in the embodiments shown in FIGS. 1 and 2, and in FIGS. 7 and 8.

It is necessary to fix the directions of magnetization of the pinned magnetic layers formed on and under the free magnetic layer toward the same direction to one another, in order to allow the characteristics of the dual spin-valve type thin film magnetic element, which is able to have a larger magnitude of ΔMR and larger output than those in the single spin-valve type thin film magnetic element, to be exhibited.

The magnetic moment MS·tp₂ of the second pinned magnetic layer (lower) 434 is larger than the magnetic moment Ms·tp₁ of the first pinned magnetic layer (lower) 432, and magnetization of the second pinned magnetic layer (lower) 434 having the larger magnetic moment Ms·tp₂ is fixed toward the Y-direction in the pinned magnetic layer 430 formed under the free magnetic layer 436 as shown in FIGS. 11 and 12 in this embodiment. The so-called synthetic magnetic moment as a sum of the magnetic moment Ms·tp₂ of the second pinned magnetic layer (lower) 434 and the magnetic moment Ms·tp₂ of the first pinned magnetic layer (lower) 432 is controlled by the larger magnetic moment Ms·tp₂ of the second pinned magnetic layer (lower) 434, and is directed toward the Y-direction.

In the pinned magnetic layer 445 formed above the free magnetic layer 436, the magnetic moment Ms·tp₁ of the first pinned magnetic layer (upper) 443 is larger than the magnetic moment Ms·tp₂ of the second pinned magnetic layer (upper) 441, and magnetization of the first pinned magnetic layer (upper) 443 having the larger magnetic moment Ms·tp₁ is fixed toward the opposite direction to the Y-direction. The so-called synthetic magnetic moment as a sum of the magnetic moment Ms·tp₁ of the first pinned magnetic layer (upper) 443 and the magnetic moment Ms·tp₂ of the second pinned magnetic layer (upper) 441 is controlled by the magnetic moment Ms·tp₁ of the first pinned magnetic layer (upper) 443, and is directed toward the opposite direction to the Y-direction.

In other words, the direction of the synthetic magnetic moment as a sum of the magnetic moment Ms·tp₁ of the first pinned magnetic layer and the magnetic moment Ms·tp₂ of the second pinned magnetic layer on the free magnetic layer 436 is opposed to that under the free magnetic layer in the dual spin-valve type thin film magnetic element 4 shown in FIGS. 11 and 12. Consequently, magnetic field rotating toward the counterclock direction is formed by the synthetic magnetic moment formed under the free magnetic layer 436 and directed toward the Y-direction, and the synthetic magnetic moment formed on the free magnetic layer 436 and directed toward the opposed direction to the Y-direction.

Consequently, the first pinned magnetic layer (lower) 432 and the first pinned magnetic layer (upper) 443, and the second pinned magnetic layer (lower) 434 and the second pinned magnetic layer (upper) 441, are magnetized to enable a stable ferrimagnetic state to be maintained.

The sense current 514 mainly flows through the non-magnetic conductive layers 435 and 440 having a small resistivity, and a sense current magnetic field is formed by the corkscrew rule. However, the direction of the sense current magnetic field formed by the sense current at the first pinned magnetic layer (lower) 432/non-magnetic intermediate layer (lower) 433/second pinned magnetic layer (lower) 434 formed under the free magnetic layer 436 may be aligned with the direction of the synthetic magnetic moment of the first pinned magnetic layer (lower) 432/non-magnetic intermediate layer (lower) 433/second pinned magnetic layer (lower) 434 by flowing the sense current 514 toward the direction shown in FIG. 12. In addition, the sense current magnetic field formed by the sense current at the first pinned magnetic layer (upper) 443/non-magnetic intermediate layer (upper) 442/second pinned magnetic layer (upper) 441 may be aligned with the direction of the synthetic magnetic moment of the first pinned magnetic layer (upper) 443/non-magnetic intermediate layer (upper) 442/second pinned magnetic layer (upper) 441.

The great advantages of aligning the direction of the sense current magnetic field with the direction of the synthetic magnetic moment are that thermal stability of the pinned magnetic layer may be enhanced, and the regenerative output may be increased by flowing a large amount of the sense current.

The relations between the direction of the sense current magnetic field and the direction of the synthetic magnetic moment as hitherto described depend on the fact that the synthetic magnetic moments of the pinned magnetic layers formed on and under the free magnetic layer 436, respectively, form a magnetic field rotating toward the counterclock direction.

The environmental temperature in a device such as a hard disk is usually increased to about 200° C., and tends to be more increased by the rotation speed of the recording medium and the increased sense current. While the exchange coupling magnetic field decreases when the environmental temperature increases as described above, the first pinned magnetic layer (lower) 432 and the first pinned magnetic layer (upper) 443, and the second pinned magnetic layer (lower) 434 and the second pinned magnetic layer (upper) 441 may be magnetized by maintaining thermally stable ferrimagnetic states among them.

In the fourth embodiment, the magnetic moment Ms·tP₁ of the first pinned magnetic layer (lower) 432 formed under the free magnetic layer 436 may be larger than the magnetic moment Ms·tP₂ of the second pinned magnetic layer (lower) 434, and the magnetic moment Ms·tP₁ of the first pinned magnetic layer (upper) 443 formed above the free magnetic layer 436 may be smaller than the magnetic moment Ms·tP₂ of the second pinned magnetic layer (upper) 441.

In the case above, the magnetic moments of the second pinned magnetic layer (lower) 434 and the magnetic moment of the second pinned magnetic layer (upper) 441 formed on and under the free magnetic layer 436, respectively, can be fixed toward the same direction to one another, besides forming a synthetic magnetic moment rotating toward the clock direction or counterclock direction as shown in the drawing, by applying a magnetic field of 400 kA/m or more (5 kOe) toward the direction that is expected to give the magnetic moments of the first pinned magnetic layer (lower) 432 and the first pinned magnetic layer (upper) 443, or toward the Y-direction or the direction opposite to the Y-direction.

The constituting material of the non-magnetic intermediate layer (lower) 443 when each of the first pinned magnetic layer (lower) 432 and the second pinned magnetic layer (lower) 434 comprise a NiFe alloy layer at the side contacting at least the non-magnetic intermediate layer (lower) 433, and preferable thickness t₃ thereof are adjusted to be the same in this embodiment as those in the cases (9) to (12) described in the first embodiment. The effects are also the same as those in the cases (9) to (12) described in the first embodiment.

Also, the constituting materials of the non-magnetic intermediate layer (upper) 442 when the first pinned magnetic layer (upper) 443 and the second pinned magnetic layer (upper) 441 comprise a NiFe alloy layer at the side contacting at least the non-magnetic intermediate layer (upper) 442, and preferable thickness t₃ thereof are adjusted to be the same in this embodiment as those in the cases (9) to (12) described in the first embodiment. The effects are also the same as those in the cases (9) to (12) described in the first embodiment.

Also, the constituting materials of the non-magnetic intermediate layer (lower) 433 when the first pinned magnetic layer (lower) 432 and the second pinned magnetic layer (lower) 434 comprise a Co alloy layer at the side contacting at least the non-magnetic intermediate layer (lower) 433, and preferable thickness t₃ thereof are adjusted to be the same in this embodiment as those in the cases (13) to (16) described in the first embodiment. The effects are also the same as those in the cases (13) to (16) described in the first embodiment.

Also, the constituting materials of the non-magnetic intermediate layer (upper) 442 when each of the first pinned magnetic layer (upper) 443 and the second pinned magnetic layer (upper) 441 comprise a Co alloy layer at the side contacting at least the non-magnetic intermediate layer (upper) 442, and preferable thickness t₃ thereof are adjusted to be the same in this embodiment as those in the cases (13) to (16) described in the first embodiment. The effects are also the same as those in the cases (13) to (16))described in the first embodiment.

According to the spin-valve type thin film magnetic element 4 in the fourth embodiment, each of the pinned magnetic layers 430 and 445 is divided into two layers of the first pinned layer and second pinned magnetic layer, respectively, via the non-magnetic intermediate layer. Thermally stable magnetization state of the pinned magnetic layers may be maintained by allowing the directions of the magnetization of the two pinned magnetic layers to be in an antiparalle state (a ferrimagnetic state) to one another by the exchange coupling magnetic field (RKKY interaction) generated between the two pinned magnetic layers.

The directions of magnetization of the second pinned magnetic layer (lower) 434 and second pinned magnetic layer (upper) 441 formed above and below the free magnetic layer 436 related to the magnitude of ΔMR may be fixed toward the same direction to one another, by appropriately aligning the magnetic moments Ms·tP₁ of the first pinned magnetic layer (lower) 432 and the first pinned magnetic layer (upper) 443 with the magnetic moments Ms·tP₂ of the second pinned magnetic layer (lower) 434 and the second pinned magnetic layer (upper) 441, besides appropriately adjusting the magnitude and direction of the applied magnetic field during heat-treatment. In addition, the magnetic field as well as the directional relation between the magnetic field and the sense current magnetic field may be formed, by forming the synthetic magnetic moments formed above and below the free magnetic layer 436 toward the opposite direction to one another, thereby making it possible to improve thermal stability of magnetization of the pinned magnetic layers.

The magnitude of Hₛ or the magnitude of H_{sf} of the pinned magnetic layers 430 and 445 may be adjusted to be larger than 40 kA/m or 4 kA/m, respectively, or the magnitude of Hₛ and the magnitude of H_{sf} may be adjusted to be larger than 40 kA/m and 4 kA/m, respectively, particularly when the combination between the constituting materials of the layers at the side where the first and second pinned magnetic layers 432 and 434 of the pinned magnetic layer (lower) 430 contact the non-magnetic intermediate layer 433, and the constituting materials of the non-magnetic intermediate layer 433, and the thickness of the non-magnetic intermediate layer 433 in each combination fall within the foregoing range, and when the combination between the constituting materials of the layers at the side where the first and second pinned magnetic layers 443 and 441 of the pinned magnetic layer (upper) 445 contact the non-magnetic intermediate layer 442, and the constituting materials of the non-magnetic intermediate layer 442, and the thickness of the non-magnetic intermediate layer 442 in each combination fall within the foregoing range.

When the magnitude of Hₛ is larger than 40 kA/m, the directions of magnetization of the first and second pinned magnetic layers constituting each pinned magnetic layer are antiparallel to one another. Since the pinned magnetic layer has a minute quantity of remnant spontaneous magnetization with an increased magnitude of H_{sf}, the magnitude of the spontaneous magnetization is amplified by the exchange coupling magnetic field with the antiferromagnetic layer in contact with the pinned magnetic layer, enabling the direction of magnetization of each pinned magnetic layer to be securely fixed.

When the magnitude of H_{sf} is larger than 4 kA/m, the range of the magnetic field for maintaining the ferrimagnetic state may be expanded to enable the direction of magnetization of each pinned magnetic layer to be securely and firmly fixed.

The magnetic head h₁ provided with the spin-valve type thin film magnetic element 4 is able to sense a minute magnitude of the external magnetic field, thereby increasing the regenerative output of the head to make it possible to use the head for a magnetic recording medium with high recording densities.

### EXAMPLES

### Example 1

A substrate layer comprising a Ta film with a thickness of 3.0 nm was deposited using a sputtering apparatus on a Si substrate on which a lower gap layer of Al has been formed. A non-magnetic intermediate layer comprising Ru was formed on the substrate by varying the thickness within a range of 0 to 1.51 nm, a second magnetic layer comprising a NiFe alloy with a thickness of 2.5 nm was additionally formed on the intermediate layer, a protective layer comprising Ta with a thickness of 3.0 nm was additionally formed on the second magnetic layer, and finally an upper gap layer comprising alumina was formed on the protective layer to complete various laminated bodies.

The structure of the laminated body manufactured as described above is abbreviated as (Si substrate/Al₂O₃ layer/Ta layer 3.0 nm/NiFe layer 4.5 nm/Ru layer 0 to 1.51 nm/NiFe layer 2.5 nm/Ta layer 3.0 nm/Al₂O₃ layer).

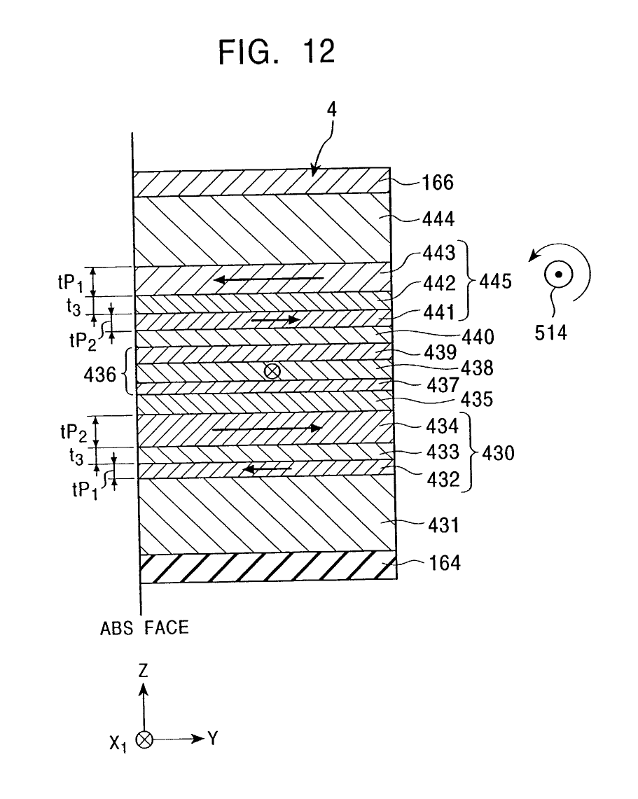

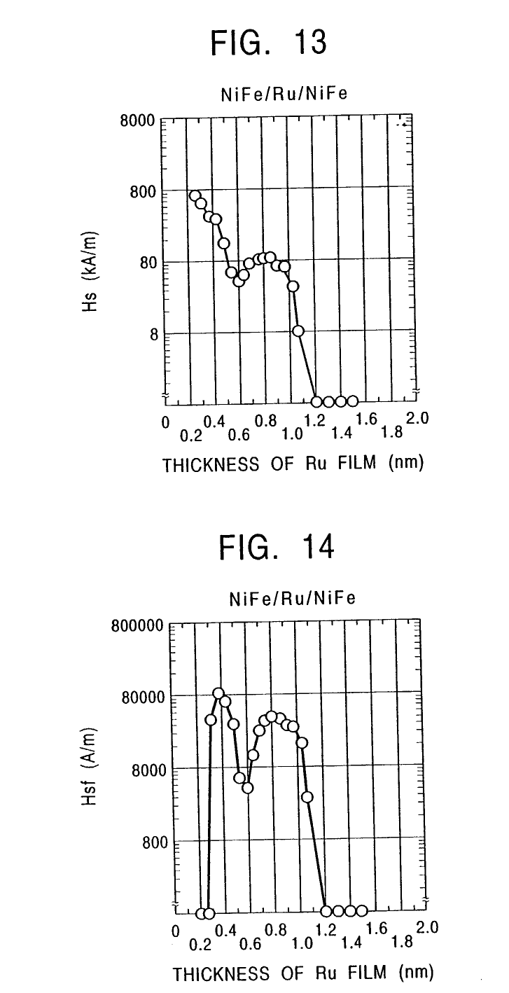

The saturation magnetic field (Hₛ) and spin-flop magnetic field (H_{sf}) of the magnetic layer (a magnetic layer with a structure of NiFe/Ru/NiFe) in the laminated body manufactured were measured, wherein Ru is inserted between the second magnetic layers. The saturation magnetic field (Hₛ) and spin-flop magnetic field (H_{sf}) were determined from the curve shown in FIG. 5 measured using a vibration sample magnetometer (VSM). The results are shown in FIGS. 13 and 14, and in Table 1. FIG. 13 is a graph showing the relation between the thickness of the Ru layer and Hₛ in the magnetic layer having the structure of NiFe/Ru/NiFe.

TABLE 1
NiFe/Ru/NiFe

| THICKNESS OF | | |
|---|---|---|
| Ru LAYER (nm) | Hₛ (kA/m) | H_{sf} (kA/m) |
| 0 | — | — |
| 0.22 | 0.80 | 80 |
| 0.27 | 640 | 80 |
| 0.32 | 520 | 36000 |
| 0.38 | 336 | 84000 |
| 0.43 | 320 | 64000 |
| 0.49 | 144 | 32000 |
| 0.54 | 88 | 6400 |
| 0.59 | 40 | 4800 |
| 0.65 | 48 | 16000 |
| 0.70 | 80 | 27200 |
| 0.76 | 80 | 38400 |
| 0.81 | 88 | 41600 |
| 0.86 | 88 | 40000 |
| 0.92 | 80 | 32000 |
| 0.97 | 64 | 30400 |
| 1.03 | 40 | 17600 |
| 1.08 | 8 | 3200 |
| 1.19 | 0.8 | 80 |
| 1.30 | 0.8 | 80 |
| 1.40 | 0.8 | 80 |
| 1.51 | 0.8 | 80 |

As is evident from FIGS. 13 and 14, and in Table 1, the relation of Hₛ>40 kA/m is valid within a range of the thickness of the Ru layer of 0.27 to 1.03 nm in the magnetic layer having the structure of NiFe/Ru/NiFe.

The relation of Hₛ>80 kA/m is valid within a range of the thickness of the Ru layer of 0.27 to 0.54 nm.

Hₛ is 40 kA/m and H_{sf} is larger than 4 kA/m within a range of the thickness of the Ru layer of 0.32 to 1.03 nm.

In addition, H_{sf} is larger than 16 kA/m within a range of the thickness of the Ru layer of 0.32 to 0.49 nm or 0.65 to 1.03 nm.

In addition, Hs is larger than 80 kA/m and H_{sf} is larger than 16 kA/m within a range of the thickness of the Ru layer of 0.32 to 0.49 nm or 0.7 to 0.92 nm.

### Example 2

Various laminated bodies were manufactured by the same method as used in Example 1, except that the non-magnetic intermediate layer comprises Cr and its thickness is changed within a range of 0 to 1.74 nm.

The structure of the laminated body manufactured as described above is abbreviated as (Si substrate/Al₂O₃ layer/Ta layer 3 nm/NiFe layer 4.5 nm/Cr layer 0 to 1.75 nm/NiFe layer 2.5 nm/Ta layer 3.0 nm/Al₂O₃ layer).

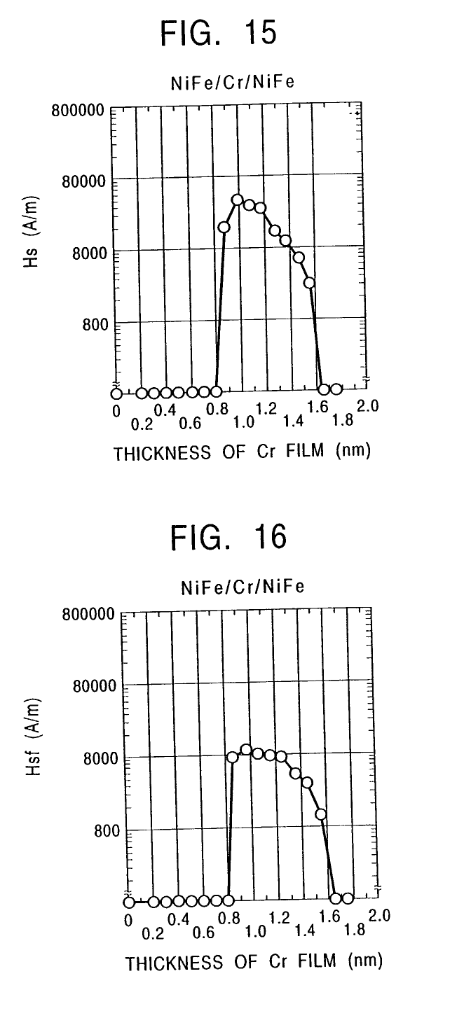

The saturation magnetic field (Hₛ) and spin-flop magnetic field (H_{sf}) of the magnetic layer (NiFe/Cr/NiFe) in the laminated body manufactured were measured by the same method as used in Example 1, wherein the non-magnetic intermediate layer comprising Cr was inserted between the first and second magnetic layers comprising NiFe. The results are shown in FIGS. 15 and 16, and in Table 2. FIG. 15 is the graph showing the relation between the thickness of the Cr layer and Hₛ. FIG. 16 is the graph showing the relation between the thickness of the Cr layer and H_{sf} in the magnetic layer having the structure of NiFe/Cr/NiFe.

TABLE 2
NiFe/Cr/NiFe

| THICKNESS OF | | |
|---|---|---|
| Cr LAYER (nm) | Hₛ (kA/m) | H_{sf} (kA/m) |
| 0 | — | — |
| 0.19 | 80 | 80 |
| 0.29 | 80 | 80 |
| 0.39 | 80 | 80 |
| 0.49 | 80 | 80 |
| 0.58 | 80 | 80 |
| 0.68 | 80 | 80 |
| 0.78 | 80 | 80 |
| 0.87 | 16000 | 7200 |
| 0.97 | 52000 | 9600 |
| 1.07 | 48000 | 8000 |
| 1.16 | 41600 | 7600 |
| 1.26 | 13600 | 7200 |
| 1.36 | 9600 | 4400 |
| 1.46 | 5600 | 3200 |
| 1.55 | 2400 | 1200 |
| 1.65 | 80 | 80 |
| 1.75 | 80 | 80 |

As is evident from FIGS. 15 and 16 and Table 2, Hₛ is larger than 40 kA/m and H_{sf} is larger than 4 kA/m within a range of the thickness of the Cr layer of 0.97 to 1.16 nm in the magnetic layer with the structure of NiFe/Cr/NiFe.

### Example 3

Various laminated bodies were manufactured by the same method as used in Example 1, except that the non-magnetic intermediate layer comprises Ir and its thickness is changed within the range of 0 to 1.73 nm.

The structure of the laminated body manufactured as described above is abbreviated as (Si substrate/Al₂O₃ layer/Ta layer 3.0 nm/NiFe layer 4.5 nm/Ir layer 0 to 1.73 nm/NiFe layer 2.5 nm/Ta layer 3.0 nm/Al₂O₃ layer).

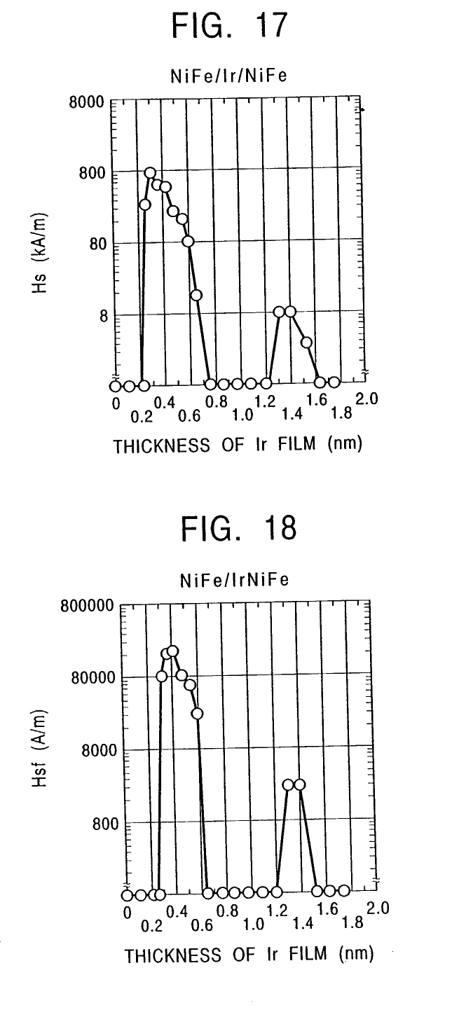

The saturation magnetic field (Hₛ) and spin-flop magnetic field (H_{sf}) of the magnetic layer (NiFe/Ir/NiFe) in the laminated body manufactured were measured by the same method as used in Example 1, wherein the non-magnetic intermediate layer comprising Ir was inserted between the first and second magnetic layers comprising NiFe. The results are shown in FIGS. 17 and 18, and in Table 3. FIG. 17 is the graph showing the relation between the thickness of the Ir layer and Hₛ in the magnetic layer having the structure of NiFe/Ir/NiFe. FIG. 18 is the graph showing the relation between the thickness of the Ir layer and H_{sf} in the magnetic layer having the structure of NiFe/Ir/NiFe.

TABLE 3
NiFe/Ir/NiFe

| THICKNESS OF | | |
|---|---|---|
| Ir LAYER (nm) | Hₛ (kA/m) | H_{sf} (kA/m) |
| 0 | — | — |
| 0.11 | 0.8 | 80 |
| 0.22 | 0.8 | 80 |
| 0.27 | 320 | 80 |
| 0.32 | 800 | 80000 |
| 0.38 | 576 | 152000 |
| 0.43 | 512 | 160000 |
| 0.49 | 240 | 80000 |
| 0.54 | 176 | 56000 |
| 0.59 | 80 | 24000 |
| 0.65 | 16 | 80 |
| 0.76 | 0.8 | 80 |
| 0.86 | 0.8 | 80 |
| 0.97 | 0.8 | 80 |
| 1.08 | 0.8 | 80 |
| 1.19 | 0.8 | 80 |
| 1.30 | 8 | 2400 |
| 1.40 | 8 | 2400 |
| 1.51 | 3.2 | 80 |
| 1.62 | 0.8 | 80 |
| 1.73 | 0.8 | 80 |

As is evident from FIGS. 17 and 18 and Table 3, Hₛ is larger than 1 koe (80 kA/m) within the range of the thickness of the Ir layer of 0.27 to 0.59 nm in the magnetic layer with the structure of NiFe/Ir/NiFe. In addition, Hₛ is larger than 80 kA/m and H_{sf} is larger than 16 kA/m within the range of the thickness of the Ir layer of 0.32 to 0.59 nm.

### Example 4

Various laminated bodies were manufactured by the same method as used in Example 1, except that the non-magnetic intermediate layer comprises Rh and its thickness is changed within the range of 0 to 2.2 nm.

The structure of the laminated body manufactured as described above is abbreviated as (Si substrate/Al₂O₃ layer/Ta layer 3.0 nm/NiFe layer 4.5 nm/Rh layer 0 to 2.2 nm/NiFe layer 2.5 nm/Ta layer 3.0 nm/Al₂O₃ layer).

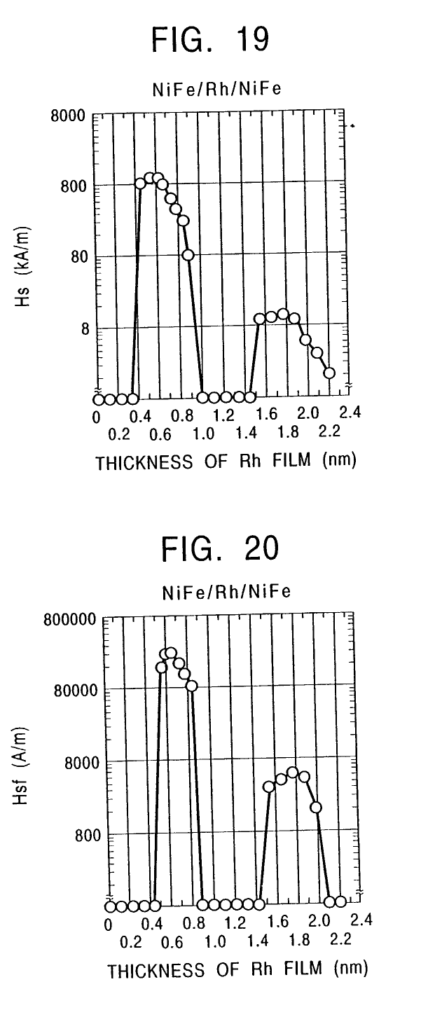

The saturation magnetic field (Hₛ) and spin-flop magnetic field (H_{sf}) of the magnetic layer (NiFe/Rh/NiFe) in the laminated body manufactured were measured by the same method as used in Example 1, wherein the non-magnetic intermediate layer comprising Rh was inserted between the first and second magnetic layers comprising NiFe. The results are shown in FIGS. 19 and 20, and in Table 4. FIG. 19 is the graph showing the relation between the thickness of the Rh layer and Hₛ in the magnetic layer having the structure of NiFe/Rh/NiFe. FIG. 20 is the graph showing the relation between the thickness of the Rh layer and Hsf in the magnetic layer having the structure of NiFe/Rh/NiFe.

TABLE 4
NiFe/Rh/NiFe

| THICKNESS OF | | |
|---|---|---|
| Rh LAYER (nm) | Hₛ (kA/m) | H_{sf} (kA/m) |
| 0 | — | — |
| 0.11 | 0.8 | 80 |
| 0.22 | 0.8 | 80 |
| 0.33 | 0.8 | 80 |
| 0.44 | 800 | 80 |
| 0.55 | 960 | 14000 |
| 0.61 | 960 | 224000 |
| 0.66 | 800 | 224000 |
| 0.72 | 496 | 160000 |
| 0.77 | 360 | 112000 |
| 0.83 | 240 | 80000 |
| 0.88 | 80 | 80 |
| 0.99 | 0.8 | 80 |
| 1.10 | 0.8 | 80 |
| 1.21 | 0.8 | 80 |
| 1.32 | 0.8 | 80 |
| 1.43 | 0.8 | 80 |
| 1.54 | 9.6 | 4000 |
| 1.65 | 10.4 | 4000 |
| 1.76 | 11.2 | 4800 |
| 1.87 | 9.6 | 4000 |
| 1.98 | 4.8 | 1600 |
| 2.09 | 3.2 | 80 |
| 2.20 | 1.6 | 80 |

As is evident from FIGS. 19 and 20 and Table 4, Hₛ is larger than 80 kA/m within the range of the thickness of the Rh layer of 0.44 to 0.88 nm in the magnetic layer with the structure of NiFe/Rh/NiFe. In addition, H_{sf} is larger than 4 kA/m within the range of the thickness of the Rh layer of 0.55 to 0.83 nm. Hₛ is larger than 80 kA/m and H_{sf} is larger than 16 kA/m within the range of the thickness of the Rh layer of 0.55 to 0.83 nm.

### Example 5

Various laminated bodies were manufactured by the same method as used in Example 1, except that the first and second magnetic layers comprising Ru and facing across the non-magnetic intermediate layer to one another comprise Co, the thickness of the first magnetic layer and the thickness of the second magnetic layer were adjusted to 2.0 nm and 3.0 nm, respectively, and the thickness of the non-magnetic intermediate layer was changed within the range of 0.22 to 1.51 nm.

The structure of the laminated body manufactured as described above is abbreviated as (Si substrate/Al₂O₃ layer/Ta layer 3.0 nm/Co layer 2.0 nm/Ru layer 0.22 to 1,51 nm/Co layer 3.0 nm/Ta layer 3.0 nm/Al₂O₃ layer).

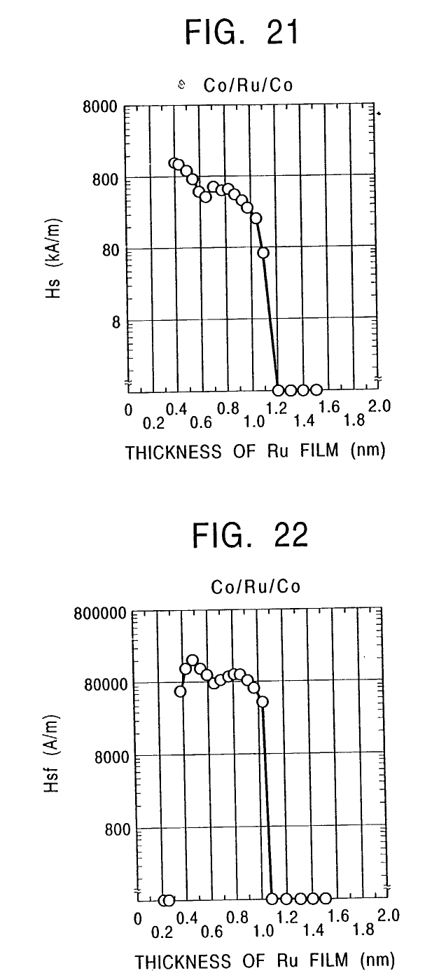

The saturation magnetic field (Hₛ) and spin-flop magnetic field (H_{sf}) of the magnetic layer (Co/Ru/Co) in the laminated body manufactured were measured by the same method as used in Example 1, wherein the non-magnetic intermediate layer comprising Ru was inserted between the first and second magnetic layers comprising Co. The results are shown in FIGS. 21 and 22, and in Table 5. FIG. 21 is the graph showing the relation between the thickness of the Ru layer and Hₛ in the magnetic layer having the structure of Co/Ru/Co. FIG. 22 is the graph showing the relation between the thickness of the Ru layer and H_{sf} in the magnetic layer having the structure of Co/Ru/Co.

TABLE 5
Co/Ru/Co

| THICKNESS OF | | |
|---|---|---|
| Ru LAYER (nm) | Hₛ (kA/m) | H_{sf} (kA/m) |
| 0 | — | — |
| 0.22 | 0.8 | 80 |
| 0.27 | 0.8 | 80 |
| 0.32 | 0.8 | 80 |
| 0.38 | 1280 | 56000 |
| 0.43 | 1200 | 112000 |
| 0.49 | 960 | 152000 |
| 0.54 | 720 | 120000 |
| 0.59 | 480 | 96000 |
| 0.65 | 400 | 72000 |
| 0.70 | 560 | 80000 |
| 0.76 | 496 | 88000 |
| 0.81 | 512 | 96000 |
| 0.86 | 440 | 96000 |
| 0.92 | 360 | 80000 |
| 0.97 | 280 | 64000 |
| 1.03 | 200 | 40000 |
| 1.08 | 64 | 80 |
| 1.19 | 0.8 | 80 |
| 1.30 | 0.8 | 80 |
| 1.40 | 0.8 | 80 |
| 1.51 | 0.8 | 80 |

As is evident from FIGS. 21 and 22 and Table 5, Hₛ is larger than 80 kA/m and H_{sf} is larger than 16 kA/m within the range of the thickness of the Ru layer of 0.38 to 1.03 nm in the magnetic layer with the structure of Co/Ru/Co.

### Example 6

Various laminated bodies were manufactured by the same method as used in Example 1, except that the non-magnetic intermediate layer comprises Cr and its thickness is changed within the range of 0 to 1.75 nm.

The structure of the laminated body manufactured as described above is abbreviated as (Si substrate/Al₂O₃ layer/Ta layer 3.0 nm/Co layer 2.0 nm/Cr layer 0 to 1.75 nm/Co layer 3.0 nm/Ta layer 3.0 nm/Al₂O₃ layer).

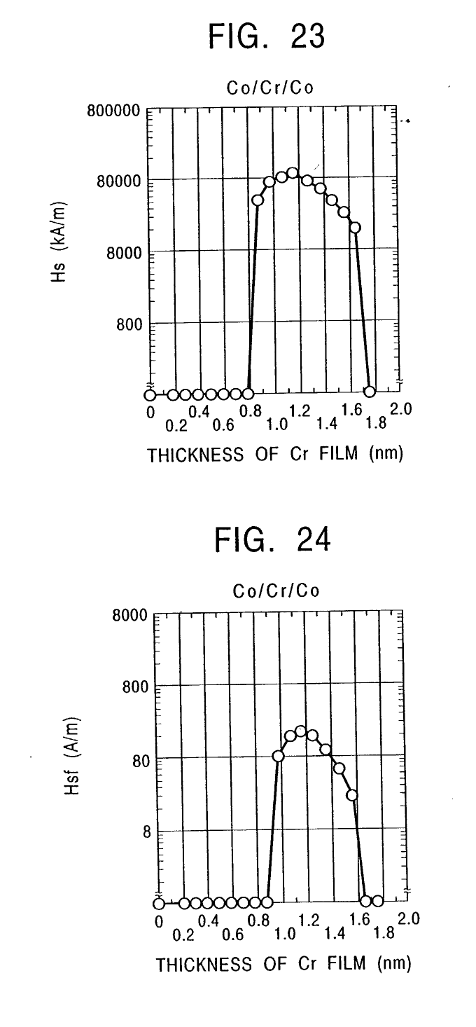

The saturation magnetic field (Hₛ) and spin-flop magnetic field (H_{sf}) of the magnetic layer (a magnetic layer with the structure of Co/Cr/Co) in the laminated body manufactured were measured by the same method as used in Example 1, wherein the non-magnetic intermediate layer comprising Cr was inserted between the first and second magnetic layers comprising Co. The results are shown in FIGS. 23 and 24, and in Table 6. FIG. 23 is the graph showing the relation between the thickness of the Ru layer and Hₛ in the magnetic layer having the structure of Co/Cr/Co. FIG. 24 is the graph showing the relation between the thickness of the Cr layer and H_{sf} in the magnetic layer having the structure of Co/Cr/Co.

TABLE 6
Co/Cr/Co

| THICKNESS OF | | |
|---|---|---|
| Cr LAYER (nm) | Hₛ (kA/m) | H_{sf} (kA/m) |
| 0 | — | — |
| 0.19 | 80 | 80 |
| 0.29 | 80 | 80 |
| 0.39 | 80 | 80 |
| 0.49 | 80 | 80 |
| 0.58 | 80 | 80 |
| 0.68 | 80 | 80 |
| 0.78 | 80 | 80 |
| 0.87 | 40000 | 80 |
| 0.97 | 81600 | 8000 |
| 1.07 | 84000 | 16000 |
| 1.16 | 92000 | 18400 |
| 1.26 | 88000 | 16000 |
| 1.36 | 60000 | 9600 |
| 1.46 | 40000 | 5600 |
| 1.55 | 28000 | 2400 |
| 1.65 | 16000 | 80 |
| 1.75 | 80 | 80 |

As is evident from FIGS. 23 and 24 and Table 6, Hₛ is larger than 40 kA/m within the range of the thickness of the Cr layer of 0.87 to 1.46 nm in the magnetic layer with the structure of Co/Cr/Co. Hₛ may be larger than 80 k/m within the range of the thickness of the Cr layer of 0.97 to 1.26 nm. Further, Hₛ may be larger than 40 kA/m and H_{sf} may be larger than 4 kA/m within the range of the thickness of the Cr layer of 0.97 to 1.46 nm. In addition, Hₛ may be larger than 80 kA/m and H_{sf} may be larger than 16 kA/m within the range of the thickness of the Cr layer of 1.07 to 1.26 nm.

### Example 7

Various laminated bodies were manufactured by the same method as used in Example 5, except that the non-magnetic intermediate layer comprises Ir and its thickness is changed within the range of 0 to 1.84 nm.

The structure of the laminated body manufactured as described above is abbreviated as (Si substrate/Al₂O₃ layer/Ta layer 3.0 nm/Co layer 2.0 nm/Ir layer 0 to 1.84 nm/Co layer 3.0 nm/Ta layer 3.0 nm/Al₂O₃ layer).

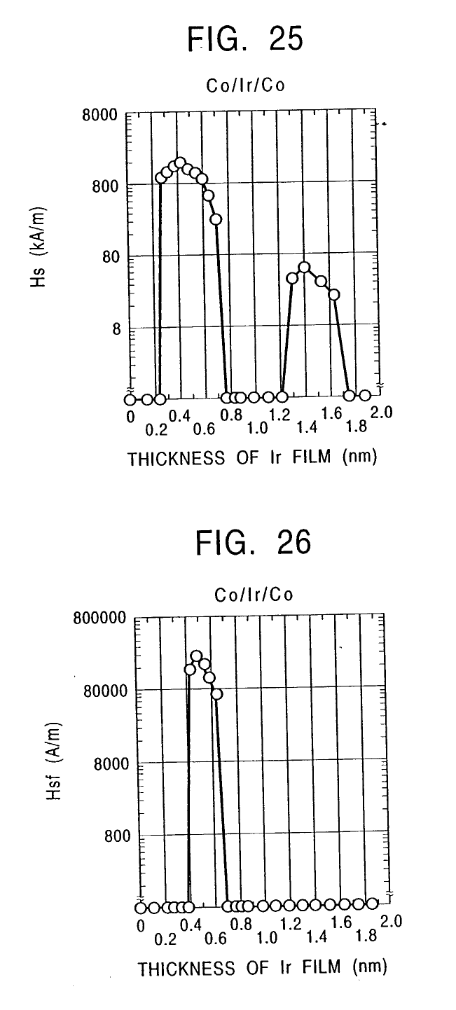

The saturation magnetic field (Hₛ) and spin-flop magnetic field (H_{sf}) of the magnetic layer (a magnetic layer with the structure of Co/Ir/Co) in the laminated body manufactured were measured by the same method as used in Example 1, wherein the non-magnetic intermediate layer comprising Ir was inserted between the first and second magnetic layers comprising Co. The results are shown in FIGS. 25 and 26, and in Table 7. FIG. 25 is the graph showing the relation between the thickness of the Ir layer and Hₛ in the magnetic layer having the structure of Co/Ir/Co. FIG. 26 is the graph showing the relation between the thickness of the Ir layer and H_{sf} in the magnetic layer having the structure of Co/Ir/Co.

TABLE 7
Co/Ir/Co

| THICKNESS OF | | |
|---|---|---|
| Ir LAYER (nm) | Hₛ (kA/m) | H_{sf} (kA/m) |
| 0 | — | — |
| 0.11 | 0.8 | 80 |
| 0.22 | 0.8 | 80 |
| 0.27 | 1040 | 80 |
| 0.32 | 1200 | 80 |
| 0.38 | 1440 | 80 |
| 0.43 | 1600 | 144000 |
| 0.49 | 1280 | 224000 |
| 0.54 | 1120 | 176000 |
| 0.59 | 960 | 112000 |
| 0.65 | 560 | 64000 |
| 0.70 | 256 | 80 |
| 0.76 | 0.8 | 80 |
| 0.81 | 0.8 | 80 |
| 0.86 | 0.8 | 80 |
| 0.97 | 0.8 | 80 |
| 1.08 | 0.8 | 80 |
| 1.19 | 0.8 | 80 |
| 1.30 | 44 | 80 |
| 1.40 | 48 | 80 |
| 1.51 | 44 | 80 |
| 1.62 | 40 | 80 |
| 1.73 | 0.8 | 80 |
| 1.84 | 0.8 | 80 |

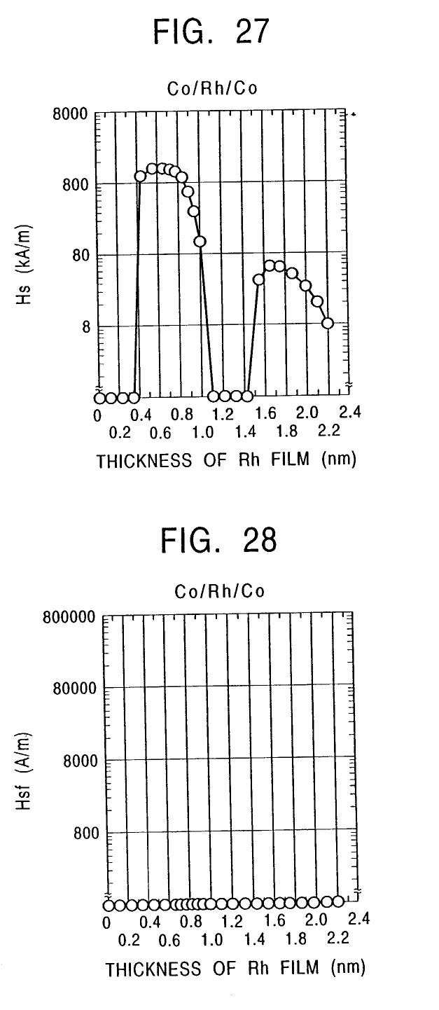

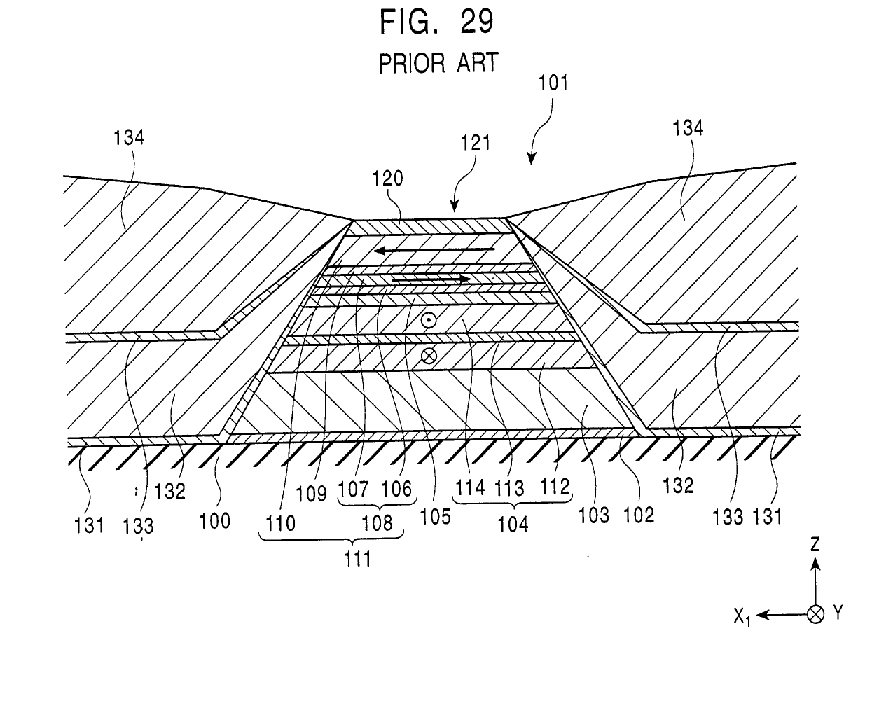

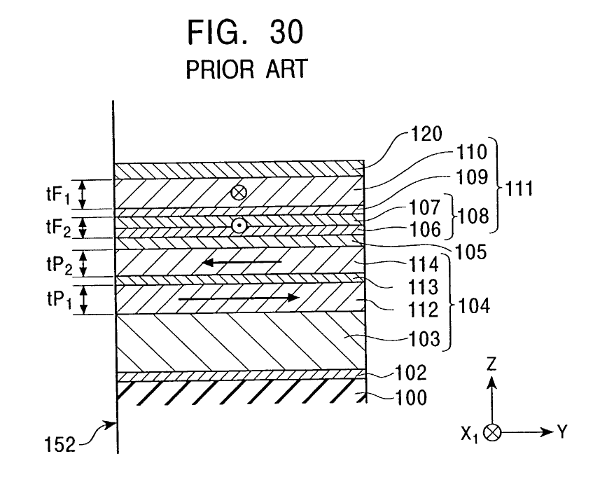

As is evident from FIGS. 25 and 27 and Table 7, Hₛ is larger than 40 kA/m within the range of the thickness of the Ir layer of 0.27 to 0.7 nm and 1.3 to 1.62 nm in the magnetic layer with the structure of Co/Ir/Co. In addition, Hₛ may be larger than 80 kA/m within the range of the thickness of the Ir layer of 0.27 to 0.7 nm. Further, Hₛ may be larger than 80 kA/m and H_{sf} may be larger than 16 kA/m within the range of the thickness of the Ir layer of 0.43 to 0.65 nm.

### Example 8

Various laminated bodies were manufactured by the same method as used in Example 5, except that the non-magnetic intermediate layer comprises Rh and its thickness is changed within the range of 0 to 2.20 nm.

The structure of the laminated body manufactured as described above is abbreviated as (Si substrate/Al₂O₃ layer/Ta layer 3.0 nm/Co layer 2.0 nm/Rh layer 0 to 2.20 nm/Co layer 3.0 nm/Ta layer 3.0 nm/Al₂O₃ layer).

The saturation magnetic field (Hₛ) and spin-flop magnetic field (H_{sf}) of the magnetic layer (a magnetic layer with the structure of Co/Rh/Co) in the laminated body manufactured were measured by the same method as used in Example 1, wherein the non-magnetic intermediate layer comprising Rh was inserted between the first and second magnetic layers comprising Co. The results are shown in FIGS. 27 and 28, and in Table 8. FIG. 27 is the graph showing the relation between the thickness of the Rh layer and Hₛ in the magnetic layer having the structure of Co/Rh/Co. FIG. 28 is the graph showing the relation between the thickness of the Rh layer and H_{sf} in the magnetic layer having the structure of Co/Rh/Co.

TABLE 8
Co/Rh/Co

| THICKNESS OF | | |
|---|---|---|
| Rh LAYER (nm) | Hₛ (kA/m) | H_{sf} (kA/m) |
| 0 | — | — |
| 0.11 | 0.8 | 80 |
| 0.22 | 0.8 | 80 |
| 0.33 | 0.8 | 80 |
| 0.44 | 1040 | 80 |
| 0.55 | 1280 | 80 |
| 0.66 | 1280 | 80 |
| 0.72 | 1200 | 80 |
| 0.77 | 1120 | 80 |
| 0.83 | 960 | 80 |
| 0.88 | 600 | 80 |
| 0.94 | 320 | 80 |
| 0.99 | 120 | 80 |
| 1.10 | 0.8 | 80 |
| 1.21 | 0.8 | 80 |
| 1.32 | 0.8 | 80 |
| 1.43 | 0.8 | 80 |
| 1.54 | 33.6 | 80 |
| 1.65 | 52 | 80 |
| 1.76 | 52 | 80 |
| 1.87 | 40 | 80 |
| 1.98 | 28 | 80 |
| 2.09 | 16 | 80 |
| 2.20 | 8 | 80 |

As is evident from FIGS. 25 and 27 and Table 7, Hₛ is larger than 40 kA/m within the range of the thickness of the Rh layer of 0.44 to 0.99 nm or 1.54 to 1.98 nm in the magnetic layer with the structure of Co/Rh/Co. In addition, Hₛ may be larger than 80 kA/m within the range of the thickness of the Ir layer of 0.27 to 0.7 nm. Further, Hₛ may be larger than 80 kA/m within the range of the thickness of the Rh layer of 0.44 to 0.99 nm.

What is claimed is:

1. A spin-valve thin film magnetic element comprising an antiferromagnetic layer, a pinned magnetic layer formed in contact with the antiferromagnetic layer in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a NiFe layer at the side making contact with at least the non-magnetic intermediate layer, the non-magnetic intermediate layer comprises Ru with a thickness of 0.27 to 1.03 nm, and the magnitude of the saturation magnetization when the directions of magnetization of the first and second magnetic layers are parallel to one another is larger than 40 kA/m.

2. A spin-valve thin film magnetic element according to claim 1, wherein the thickness of the non-magnetic intermediate layer comprising Ru is 0.32 to 1.03 nm instead of 0.27 to 1.03 nm, and the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

3. A spin-valve thin film magnetic element according to claim 2, wherein the saturation magnetic field when the directions of magnetization of the first and second magnetic layers are parallel to one another is larger than 40 kA/m.

4. A spin-valve thin film magnetic element comprising an antiferromagnetic layer, a pinned magnetic layer formed in contact with the antiferromagnetic layer in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a NiFe layer at the side making contact with at least the non-magnetic intermediate layer, the non-magnetic intermediate layer comprises Cr with a thickness of 0.97 to 1.16 nm, and the magnitude of the saturation magnetization when the directions of magnetization of the first and second magnetic layers are parallel to one another is larger than 40 kA/m.

5. A spin-valve thin film magnetic element according to claim 4, wherein the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

6. A spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a NiFe layer at the side making contact with at least the non-magnetic intermediate layer, the non-magnetic intermediate layer comprises Ir with a thickness of 0.27 to 0.59 nm, and the magnitude of the saturation magnetization when the directions of magnetization of the first and second magnetic layers are parallel to one another is larger than 40 kA/m.

7. A spin-valve thin film magnetic element according to claim 6, wherein the thickness of the non-magnetic intermediate layer comprising Ir is 0.32 to 0.59 nm instead of 0.27 to 0.59 nm, and the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

8. A spin-valve thin film magnetic element according to claim 7, wherein the saturation magnetization when the directions of magnetization of the first and second magnetic layers are parallel to one another is larger than 40 kA/m.

9. A spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a NiFe layer at the side making contact with at least the non-magnetic intermediate layer, the non-magnetic intermediate layer comprises Ru with a thickness of 0.44 to 0.88 nm, and the magnitude of the saturation magnetization when the directions of magnetization of the first and second magnetic layers are parallel to one another is larger than 40 kA/m.

10. A spin-valve thin film magnetic element according to claim 9, wherein the thickness of the non-magnetic intermediate layer comprising Rh is 0.55 to 0.83 nm or 1.54 to 1.87 nm instead of 0.44 to 0.88 nm, and the spin-flop magnetic field that causes spin-flop transition in the first and second magnetic layers is larger than 4 kA/m instead of the saturation magnetic field of larger than 40 kA/m when the first and second magnetic layers are parallel to one another.

11. A spin-valve thin film magnetic element according to claim 10, wherein the thickness of the non-magnetic intermediate layer comprising Rh is 0.55 to 0.83 nm instead of 0.55 to 0.83 nm or 1.54 to 1.87 nm, and the saturation magnetic field when the directions of magnetization of the first and second magnetic layers are parallel to one another is larger than 40 kA/m.

12. A spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a Co layer at the side making contact with at least the non-magnetic intermediate layer, the non-magnetic intermediate layer comprises Ru with a thickness of 0.38 to 1.03 nm, and the magnitude of the saturation magnetization when the directions of magnetization of the first and second magnetic layers are parallel to one another is larger than 40 kA/m.

13. A spin-valve thin film magnetic element according to claim 12, wherein the spin-flop magnetic field that causes spin-flop transition of the first and second magnetic layers is larger than 4 kA/m, instead of the saturation magnetic field of larger than 40 kA/m when the directions of magnetization of the first and second magnetic layers are parallel to one another.

14. A spin-valve thin film magnetic element according to claim 13, wherein the saturation magnetic field when the directions of magnetization of the first and second magnetic layers are parallel to one another is larger than 40 kA/m.

15. A spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a Co layer at the side making contact with at least the non-magnetic intermediate layer, the non-magnetic intermediate layer comprises Cr with a thickness of 0.87 to 1.46 nm, and the magnitude of the saturation magnetization when the directions of magnetization of the first and second magnetic layers are parallel to one another is larger than 40 kA/m.

16. A spin-valve thin film magnetic element according to claim 15, wherein the thickness of the non-magnetic intermediate layer comprising Cr is 0.97 to 1.46 nm instead of 0.87 to 1.46 nm, and the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

17. A spin-valve thin film magnetic element according to claim 16, wherein the saturation magnetic field when the directions of magnetization of the first and second magnetic layers are in parallel to one another is larger than 40 kA/m.

18. A spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a Co layer at the side making contact with at least the non-magnetic intermediate layer, the non-magnetic intermediate layer comprises Ir with a thickness of 0.27 to 0.7 nm or 1.3 to 1.62 nm, and the magnitude of the saturation magnetization when the directions of magnetization of the first and second magnetic layers are parallel to one another is larger than 40 kA/m.

19. A spin-valve thin film magnetic element according to claim 18, wherein the thickness of the non-magnetic intermediate layer comprising Ir is 0.43 to 0.65 nm instead of 0.27 to 0.7 nm or 1.3 to 1.62 nm, and the spin-flop magnetic field that causes spin-flop transition in the first and second magnetic layers is larger than 4 kA/m, instead of the saturation magnetic field of larger than 40 kA/m when the directions of magnetization of the first and second magnetic layers are parallel to one another.

20. A spin-valve thin film magnetic element according to claim 19, wherein the saturation magnetization when the first and second magnetic layers are parallel to one another is larger than 40 kA/m.

21. A spin-valve thin film magnetic element comprising an antiferromagnetic layer, a pinned magnetic layer formed in contact with the antiferromagnetic layer and in which the direction of magnetization is fixed by an exchange coupling magnetic field with the antiferromagnetic layer, a non-magnetic conductive layer in contact with the pinned magnetic layer, and a free magnetic layer in contact with the non-magnetic conductive layer,
the non-magnetic conductive layer, the pinned magnetic layer and the antiferromagnetic layer being provided on one side or on both sides of the free magnetic layer along the direction of thickness,
at least one of the pinned magnetic layer and the free magnetic layer being divided into two layers of a first magnetic layer and a second magnetic layer via a non-magnetic intermediate layer, the directions of magnetization of the first and second magnetic layers being in an antiparallel relation to one another, and at least one of the pinned magnetic layer and the free magnetic layer being in a ferrimagnetic state,
wherein each of the first and second magnetic layers has a Co layer at the side making contact with at least the non-magnetic intermediate layer, the non-magnetic intermediate layer comprises Rh with a thickness of 0.44 to 0.99 nm or 1.54 to 1.98 nm, and the magnitude of the saturation magnetization when the directions of magnetization of the first and second magnetic layers are parallel to one another is larger than 40 kA/m.

22. A spin-valve thin film magnetic element according to claim 1, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

23. A spin-valve thin film magnetic element according to claim 1, wherein the antiferromagnetic layer comprises α-Fe₂O₃.

24. A thin film magnetic head comprising the spin-valve type thin film magnetic element according to claim 1.

25. A spin-valve thin film magnetic element according to claim 4, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

26. A spin-valve thin film magnetic element according to claim 4, wherein the antiferromagnetic layer comprises α-Fe₂O₃.

27. A thin film magnetic head comprising the spin-valve type thin film magnetic element according to claim 4.

28. A spin-valve thin film magnetic element according to claim 6, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

29. A spin-valve thin film magnetic element according to claim 6, wherein the antiferromagnetic layer comprises α-Fe₂O₃.

30. A thin film magnetic head comprising the spin-valve type thin film magnetic element according to claim 6.

31. A spin-valve thin film magnetic element according to claim 9, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

32. A spin-valve thin film magnetic element according to claim 9, wherein the antiferromagnetic layer comprises α-Fe₂O₃.

33. A thin film magnetic head comprising the spin-valve type thin film magnetic element according to claim 9.

34. A spin-valve thin film magnetic element according to claim 12, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

35. A spin-valve thin film magnetic element according to claim 12, wherein the antiferromagnetic layer comprises α-Fe₂O₃.

36. A thin film magnetic head comprising the spin-valve type thin film magnetic element according to claim 12.

37. A spin-valve thin film magnetic element according to claim 15, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

38. A spin-valve thin film magnetic element according to claim 15, wherein the antiferromagnetic layer comprises α-Fe₂O₃.

39. A thin film magnetic head comprising the spin-valve type thin film magnetic element according to claim 15.

40. A spin-valve thin film magnetic element according to claim 18, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

41. A spin-valve thin film magnetic element according to claim 18, wherein the antiferromagnetic layer comprises α-Fe₂O₃.

42. A thin film magnetic head comprising the spin-valve type thin film magnetic element according to claim 18.

43. A spin-valve thin film magnetic element according to claim 21, wherein the antiferromagnetic layer comprises one of the alloys represented by a formula of X—Mn (wherein X represents one of the elements selected from Pt, Pd, Ru, Ir, Rh and Os) or X′—Mn (wherein X′ represents one or plural elements selected from Pt, Pd, Cr, Ni, Ru, Ir, Rh, Os, Au, Ag, Ne, Ar, Xe and Kr).

44. A spin-valve thin film magnetic element according to claim 21, wherein the antiferromagnetic layer comprises α-Fe₂O₃.

45. A thin film magnetic head comprising the spin-valve type thin film magnetic element according to claim 21.
